(19) United States
(12) Patent Application Publication
(10) Pub. No.: US 2024/0306730 A1
(43) Pub. Date: Sep. 19, 2024

(54) CIRCUIT UNIT FOR AEROSOL GENERATION DEVICE, AND DEVICE AND PROGRAM FOR AEROSOL GENERATION

(71) Applicant: Japan Tobacco Inc., Tokyo (JP)

(72) Inventors: Takuma NAKANO, Tokyo (JP); Kazuma MIZUGUCHI, Tokyo (JP)

(73) Assignee: Japan Tobacco Inc., Tokyo (JP)

(21) Appl. No.: 18/664,317

(22) Filed: May 15, 2024

Related U.S. Application Data
(63) Continuation of application No. PCT/JP2021/042555, filed on Nov. 19, 2021.

(51) Int. Cl. A24F 40/57; A24F 40/51; A24F 40/53; H05B 1/02

(52) U.S. Cl. CPC A24F 40/57; A24F 40/51; A24F 40/53; H05B 1/0252

(57) ABSTRACT

A circuit unit for an aerosol generation device that is equipped with a control unit for controlling electric power supply to a load that heats an aerosol source. In the case where the control unit performs second control to heat the load to a second temperature that is lower than a first temperature, at which an aerosol is generated, before first control to heat the load to the first temperature, when the interval between aerosol inhalations is shorter than in a first period, the control unit controls the amount of the electric power supplied to the load in the first control and/or the amount of the electric power supplied to the load in the second control to be smaller than a standard value.

### CROSS-REFERENCE TO RELATED APPLICATION

This application is a continuation of International Application No. PCT/JP2021/042555 filed on Nov. 19, 2021, the entire content of which is incorporated herein by reference.

### TECHNICAL FIELD

The present disclosure relates to a circuit unit of an aerosol generation device, the aerosol generation device, and a program.

### BACKGROUND ART

In an aerosol generation device for heating a liquid containing, for example, a flavor to generate an aerosol, energization of a heater is started in response to sensing of a user's inhalation action, and the liquid in a glass fiber called a wick is atomized (aerosolized). The aerosol is generated in response to the temperature of the liquid in the week reaching the boiling point.

### CITATION LIST

### Patent Literature

PTL 1: U.S. Patent Application Publication No. 2020/0329776

A recent aerosol generation device may be provided with a function of energizing the heater even during non-inhalation to preliminarily heat the liquid temperature at the start of inhalation. This function is referred to as “preheating” to distinguish it from heating involving generation of aerosol (hereinafter referred to as “main heating”).

### SUMMARY

According to an aspect of the present disclosure, a circuit unit of an aerosol generation device, including a controller that controls supply of electric power to a load that heats an aerosol source. In a case where first control for heating the load to a first temperature at which an aerosol is generated is preceded by second control for heating the load to a second temperature lower than the first temperature, the controller performs control such that at least one of an amount of electric power to be supplied to the load in the first control and an amount of electric power to be supplied to the load in the second control is smaller than a reference value when an interval between inhalations of the aerosol is shorter than a first period.

### BRIEF DESCRIPTION OF DRAWINGS

FIG. 1 is a diagram illustrating an example external configuration of an aerosol generation device provided in Embodiment 1.

FIG. 2 is a diagram schematically illustrating an internal configuration of the aerosol generation device provided in Embodiment 1.

FIGS. 3A and 3B are diagrams illustrating a preheating time and a main-heating time. FIG. 3A illustrates the arrangement of the preheating time and the main-heating time, and FIG. 3B illustrates a temperature change of an aerosol source.

FIG. 4 is a flowchart illustrating an example of control of the main-heating time by a controller used in Embodiment 1.

FIGS. 5A and 5B are diagrams illustrating an example of setting of the main-heating time according to the presence or absence of preheating and the length of a puff interval. FIG. 5A illustrates an example of setting of the main-heating time without the preheating, and FIG. 5B illustrates an example of setting of the main-heating time with the preheating.

FIGS. 6A to 6C are diagrams illustrating a relationship between a puff interval and a set main-heating time in Embodiment 1. FIG. 6A illustrates example timings of inhalation, FIG. 6B illustrates an example of setting of the main-heating time without the preheating, and FIG. 6C illustrates an example of setting of the main-heating time with the preheating.

FIG. 7 is a flowchart illustrating an example of control of the main-heating time by a controller used in Embodiment 2.

FIGS. 8A to 8C are diagrams illustrating a relationship between a puff interval and a set main-heating time in Embodiment 2. FIG. 8A illustrates example timings of inhalation, FIG. 8B illustrates an example of setting of the main-heating time without the preheating, and FIG. 8C illustrates an example of setting of the main-heating time with the preheating.

FIG. 9 is a flowchart illustrating an example of control of the main-heating time by a controller used in Embodiment 3.

FIGS. 10A to 10C are diagrams illustrating a relationship between a puff interval and a set main-heating time in Embodiment 3. FIG. 10A illustrates example timings of inhalation, FIG. 10B illustrates an example of setting of the main-heating time without the preheating, and FIG. 10C illustrates an example of setting of the main-heating time with the preheating.

FIG. 11 is a flowchart illustrating an example of control of the main-heating time by a controller used in Embodiment 4.

FIGS. 12A to 12C are diagrams illustrating a relationship between a puff interval and a set main-heating time in Embodiment 4. FIG. 12A illustrates example timings of inhalation, FIG. 12B illustrates an example of setting of the main-heating time without the preheating, and FIG. 12C illustrates an example of setting of the main-heating time with the preheating.

FIG. 13 is a diagram schematically illustrating an internal configuration of an aerosol generation device provided in Embodiment 5.

FIG. 14 is a flowchart illustrating an example of control of the main-heating time by a controller used in Embodiment 5.

FIGS. 15A to 15E are diagrams illustrating a relationship between a puff interval and a set main-heating time in Embodiment 5. FIG. 15A illustrates example timings of inhalation, FIG. 15B illustrates a temperature change of a heater in the absence of preheating, FIG. 15C illustrates an example of setting of the main-heating time in the absence of preheating, FIG. 15D illustrates a temperature change of the heater in the presence of preheating, and FIG. 15E illustrates an example of setting of the main-heating time in the presence of preheating.

FIG. 16 is a diagram schematically illustrating an internal configuration of an aerosol generation device provided in Embodiment 6.

FIG. 17 is a flowchart illustrating an example of control of the main-heating time by a controller used in Embodiment 6.

FIGS. 18A to 18E are diagrams illustrating a relationship between a puff interval and a set main-heating time in Embodiment 6. FIG. 18A illustrates example timings of inhalation, FIG. 18B illustrates a change in the resistance value of a heater in the absence of preheating, FIG. 18C illustrates an example of setting of the main-heating time in the absence of preheating, FIG. 18D illustrates a change in the resistance value of the heater in the presence of preheating, and FIG. 18E illustrates an example of setting of the main-heating time in the presence of preheating.

FIG. 19 is a diagram schematically illustrating an internal configuration of an aerosol generation device provided in Embodiment 7.

FIG. 20 is a flowchart illustrating an example of control of the main-heating time by a controller used in Embodiment 7.

FIGS. 21A to 21E are diagrams illustrating a relationship between a puff interval and a set main-heating time in Embodiment 7. FIG. 21A illustrates example timings of inhalation, FIG. 21B illustrates a change in the temperature of a liquid guide in the absence of preheating, FIG. 21C illustrates an example of setting of the main-heating time in the absence of preheating, FIG. 21D illustrates a change in the temperature of the liquid guide in the presence of preheating, and FIG. 21E illustrates an example of setting of the main-heating time in the presence of preheating.

FIG. 22 is a diagram schematically illustrating an internal configuration of an aerosol generation device provided in Embodiment 8.

FIG. 23 is a flowchart illustrating an example of control of the main-heating time by a controller used in Embodiment 8.

FIGS. 24A to 24D are diagrams illustrating a relationship between a puff interval and a set main-heating time in Embodiment 8. FIG. 24A illustrates example timings of inhalation, FIG. 24B illustrates a change in ambient air temperature, FIG. 24C illustrates an example of setting of the main-heating time without the preheating, and FIG. 24D illustrates an example of setting of the main-heating time with the preheating.

FIG. 25 is a flowchart illustrating an example of control of the main-heating time by a controller used in Embodiment 9.

FIGS. 26A to 26C are diagrams illustrating a relationship between a puff interval and a set main-heating time in Embodiment 9. FIG. 26A illustrates example timings of inhalation, FIG. 26B illustrates an example of setting of the main-heating time when a predicted puff interval is equal to or longer than a first period, and FIG. 26C illustrates an example of setting of the main-heating time when the predicted puff interval is shorter than the first period.

FIG. 27 is a flowchart illustrating an example of control of the main-heating time by a controller used in Embodiment 10.

FIGS. 28A to 28C are diagrams illustrating a relationship between a puff interval and a set main-heating time in Embodiment 10. FIG. 28A illustrates example timings of inhalation, FIG. 28B illustrates an example of setting of the main-heating time when the number of consecutive short puffs is equal to or less than a first number, and FIG. 28C illustrates an example of setting of the main-heating time when the number of consecutive short puffs is greater than the first number.

FIG. 29 is a flowchart illustrating an example of control of the main-heating time by a controller used in Embodiment 11.

FIG. 30 is a flowchart illustrating an example of control of the main-heating time by a controller used in Embodiment 12.

FIG. 31 is a diagram schematically illustrating an internal configuration of an aerosol generation device provided in Embodiment 13.

FIG. 32 is a flowchart illustrating an example of control of the main-heating time by a controller used in Embodiment 13.

FIG. 33 is a flowchart illustrating an example process for setting the main-heating time without the preheating and an example process for setting the main-heating time with the preheating.

FIGS. 34A and 34B are diagrams illustrating an example of setting of the main-heating time according to the amounts of residual liquid in the absence of preheating and in the presence of preheating. FIG. 34A illustrates an example of setting of the main-heating time without the preheating, and FIG. 34B illustrates an example of setting of the main-heating time with the preheating.

FIG. 35 is a flowchart illustrating an example of control of the main-heating time by a controller used in Embodiment 14.

FIG. 36 is a flowchart illustrating an example of control of the main-heating time by a controller used in Embodiment 15.

FIG. 37 is a flowchart illustrating an example of control of the main-heating time by a controller used in Embodiment 16.

FIG. 38 is a diagram illustrating an example external configuration of an aerosol generation device provided in Embodiment 17.

FIG. 39 is a diagram schematically illustrating an example internal configuration of an aerosol generation device provided in Embodiment 18.

### DESCRIPTION OF EMBODIMENTS

Embodiments of the present disclosure will be described hereinafter with reference to the drawings. In the individual drawings, the same components are denoted by the same reference numerals.

### Embodiment 1

### <External Configuration>

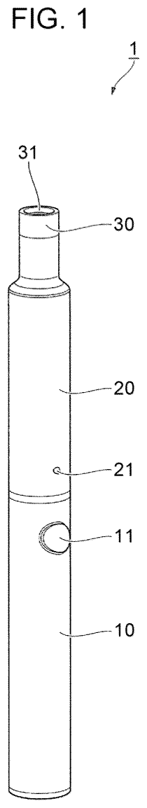

FIG. 1 is a diagram illustrating an example external configuration of an aerosol generation device 1 provided in Embodiment 1.

The aerosol generation device 1 illustrated in FIG. 1 is one form of an electronic cigarette and generates an aerosol to which a flavor is imparted without combustion. The electronic cigarette illustrated in FIG. 1 has a substantially cylindrical shape.

The aerosol generation device 1 illustrated in FIG. 1 includes a plurality of units. In FIG. 1, the plurality of units include a power supply unit 10, a cartridge 20 that incorporates an aerosol source, and a cartridge 30 that incorporates a flavor source.

In the present embodiment, the cartridge 20 is removably attached to the power supply unit 10, and the cartridge 30 is removably attached to the cartridge 20. In other words, the cartridge 20 and the cartridge 30 are each replaceable.

The power supply unit 10 incorporates an electronic circuit and so on. The power supply unit 10 is one form of a circuit unit. The power supply unit 10 has a power button 11 on a side surface thereof. The power button 11 is an example of an operation unit to be used by a user to input an instruction to the power supply unit 10.

The cartridge 20 incorporates a liquid storage for storing a liquid as the aerosol source, a liquid guide for drawing the liquid from the liquid storage by capillary action, and a heater for heating and vaporizing the liquid held in the liquid guide.

The cartridge 20 has a side surface thereof an inlet hole for air (hereinafter referred to as “air inlet hole”) 21. The air flowing in through the air inlet hole 21 passes through the inside of the cartridge 20 and is released from the cartridge 30. The cartridge 20 is also referred to as an atomizer.

The cartridge 30 incorporates a flavor unit for imparting a flavor to an aerosol. The cartridge 30 is provided with a mouthpiece 31.

### <Internal Configuration>

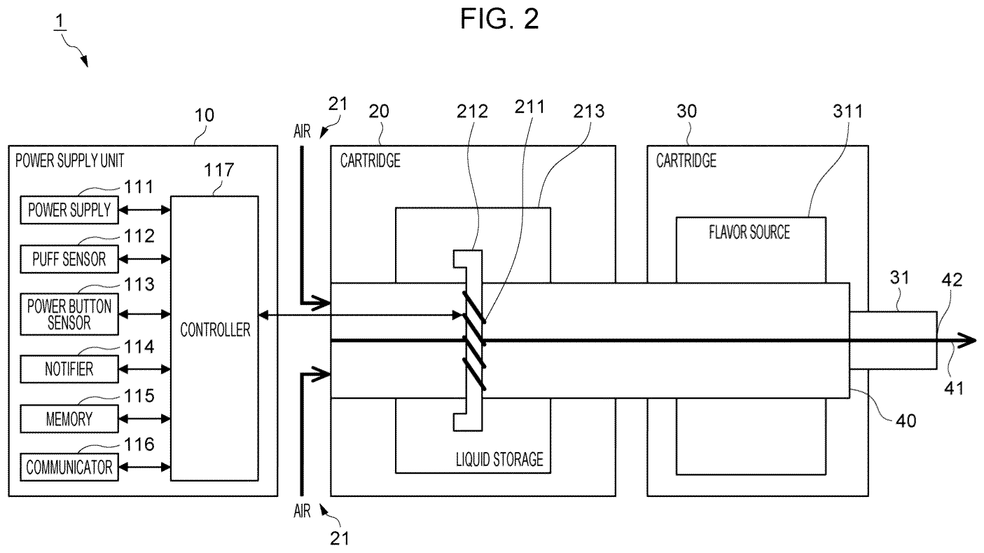

FIG. 2 is a diagram schematically illustrating an internal configuration of the aerosol generation device 1 provided in Embodiment 1.

The aerosol generation device 1 includes the power supply unit 10 and the cartridges 20 and 30.

The power supply unit 10 incorporates a power supply 111, a puff sensor 112, a power button sensor 113, a notifier 114, a memory 115, a communicator 116, and a controller 117.

The cartridge 20 incorporates a heater 211, a liquid guide 212, and a liquid storage 213.

The cartridge 30 incorporates a flavor source 311. One end of the cartridge 30 is used as the mouthpiece 31.

The cartridges 20 and 30 have formed therein an airflow path 40 connected to the air inlet hole 21.

The power supply 111 is a device that stores electric power necessary for operation. The power supply 111 supplies electric power to the individual components of the aerosol generation device 1 under the control of the controller 117. The power supply 111 is configured as, for example, a rechargeable battery such as a lithium ion secondary battery.

The puff sensor 112 is a sensor that detects inhalation of an aerosol by the user, and is formed of, for example, a flow sensor. The puff sensor 112 is an example of a first sensor.

The power button sensor 113 is a sensor that detects an operation performed on the power button 11 (see FIG. 1), and is formed of, for example, a pressure sensor. The power supply unit 10 is provided with various sensors in addition to the puff sensor 112 and the power button sensor 113.

The notifier 114 is a device to be used to notify the user of information. Examples of the notifier 114 include a light-emitting device, a display device, a sound output device, and a vibration device.

The memory 115 is a device that stores various types of information necessary for the operation of the aerosol generation device 1. A non-volatile storage medium such as a flash memory is used as the memory 115.

The communicator 116 is a communication interface that is in conformity with a wired or wireless communication standard. Examples of the communication standard to be used include Wi-Fi (registered trademark) and Bluetooth (registered trademark).

The controller 117 is a device that functions as an arithmetic processing unit or a control device, and controls the overall operation in the aerosol generation device 1 through execution of various programs. The controller 117 is implemented by an electronic circuit such as a CPU (=Central Processing Unit) or an MPU (=Micro Processing Unit).

The liquid storage 213 is a tank for storing the aerosol source. The aerosol source stored in the liquid storage 213 is atomized to generate an aerosol.

A liquid such as polyhydric alcohol, such as glycerine or propylene glycol, or water is used as the aerosol source. The aerosol source may include a flavor component derived from tobacco or not derived from tobacco.

When the aerosol generation device 1 is a medical inhaler such as a nebulizer, the aerosol source may include medicine.

The liquid guide 212 is a member that guides the aerosol source, which is a liquid, from the liquid storage 213 to a heating region and holds the aerosol source in the heating region. A member called a wick formed by twisting a fiber material such as a glass fiber or a porous material such as porous ceramic is used as the liquid guide 212. When the liquid guide 212 is formed of a wick, the aerosol source stored in the liquid storage 213 is guided to the heating region by capillary action of the wick.

The heater 211 is a member that heats the aerosol source held in the heating region to atomize the aerosol source to generate an aerosol.

In FIG. 2, the heater 211 is a coil and is wound around the liquid guide 212. A region of the liquid guide 212 around which the coil is wound serves as the heating region. Heat produced by the heater 211 allows the temperature of the aerosol source held in the heating region to rise to the boiling point, and an aerosol is generated. The boiling point is an example of a first temperature.

The heater 211 produces heat when supplied with electric power from the power supply 111. The supply of electric power to the heater 211 is started when a predetermined condition is satisfied. Examples of the predetermined condition include the start of inhalation by the user, pressing of the power button 11 a predetermined number of times, and input of certain information determined in advance. In the present embodiment, the supply of electric power to the heater 211 is started in response to the detection of inhalation.

The supply of electric power to the heater 211 is stopped when a predetermined condition is satisfied. Examples of the predetermined condition include the end of inhalation by the user, the end of a main-heating time described below, pressing and holding down of the power button 11, and input of certain information determined in advance. In the present embodiment, the supply of electric power to the heater 211 is stopped in response to the end of inhalation.

The heater 211, as used, as used here, is an example of a load that consumes electric power.

The flavor source 311 is a structural element that imparts a flavor component to the aerosol generated in the cartridge 20. The flavor source 311 includes a flavor component derived from tobacco or not derived from tobacco.

The airflow path 40, which passes through the inside of the cartridge 20 and the cartridge 30, is a flow path of air and aerosol inhaled by the user. The airflow path 40 has a tubular structure having the air inlet hole 21 as an inlet of air and an air outlet hole 42 as an outlet of air.

The liquid guide 212 is disposed upstream of the airflow path 40, and the flavor source 311 is disposed downstream of the airflow path 40.

As the user inhales, the air flowing in through the air inlet hole 21 is mixed with the aerosol generated by the heater 211. A gas as a result of mixture passes through the flavor source 311 and is conveyed to the air outlet hole 42, as indicated by an arrow 41. When the gas obtained by mixing the aerosol and the air passes through the flavor source 311, the flavor component of the flavor source 311 is imparted to the gas.

The cartridge 30 may be used without the flavor source 311 mounted therein.

The mouthpiece 31 is a member to be held in the user's mouth during inhalation. The mouthpiece 31 is provided with the air outlet hole 42. The user inhales with the mouthpiece 31 held in their mouth, thereby being able to take the gas, which is obtained by mixing the aerosol and the air, into their oral cavity.

While an example internal configuration of the aerosol generation device 1 has been described above, the configuration illustrated in FIG. 2 is merely one form.

For example, the aerosol generation device 1 can be configured such that the cartridge 30 is not included in the aerosol generation device 1. In this case, the cartridge 20 is provided with the mouthpiece 31.

Further, the aerosol generation device 1 can include a plurality of types of aerosol sources. A plurality of types of aerosols generated from the plurality of types of aerosol sources may be mixed in the airflow path 40 to produce a chemical reaction, thereby generating still another type of aerosol.

In addition, the method for atomizing the aerosol source is not limited to heating using the heater 211. For example, the technique of induction heating may be used to atomize the aerosol source.

### <Control of Length of Main-Heating Time>

### <Preheating and Main Heating>

The present embodiment provides a case where the aerosol generation device 1 has a function of preliminarily heating the heater 211 (see FIG. 2) prior to main heating.

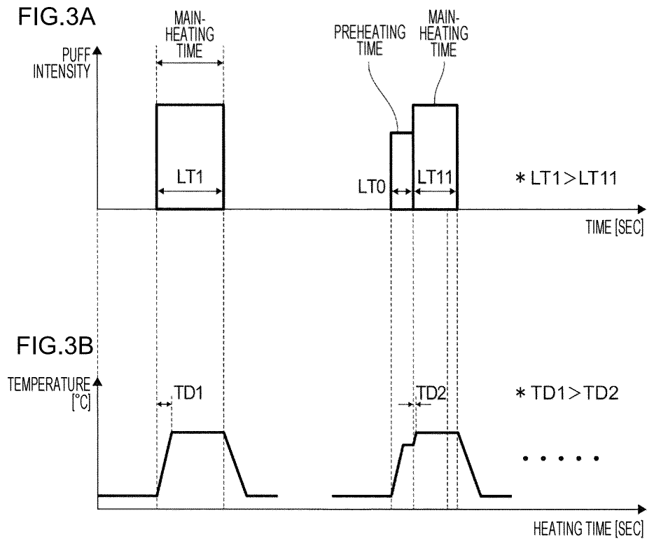

FIGS. 3A and 3B are diagrams illustrating a preheating time LT0 and a main-heating time LT11. FIG. 3A illustrates the arrangement of the preheating time LT0 and the main-heating time LT11, and FIG. 3B illustrates a temperature change of the aerosol source. In FIG. 3A, the vertical axis represents puff intensity. In FIG. 3B, the vertical axis represents temperature. In FIGS. 3A and 3B, the horizontal axis represents time. The puff intensity is detected by the puff sensor. In the present embodiment, the puff intensity is detected as the presence or absence of a puff. Alternatively, the puff intensity may be defined as the amount of air inhaled.

Main-heating times LT1 and LT11 are times for heating the aerosol source held in the liquid guide 212 (see FIG. 2) to the vaporization temperature. The main-heating times LT1 and LT11 are an example of first control.

On the other hand, as illustrated in FIG. 3A, the preheating time LT0 is a time arranged immediately before the main-heating time LT11 and is a time for preliminarily heating the aerosol source. In other words, preheating is heating for heating in advance the liquid temperature of the aerosol source in the liquid guide 212 to room temperature or higher and lower than the boiling point. The preheating time LT0 is an example of second control.

In FIG. 3A, the main-heating time with the use of the preheating is denoted by LT11, and the main-heating time without the use of the preheating is denoted by LT1 for distinction.

The liquid temperature of the aerosol source in the preheating is maintained at a target temperature near the boiling point. The target temperature, as used here, is an example of a second temperature. As a result, the electric power to be supplied in response to the start of the main-heating time LT11 can be allocated more to the generation of aerosol than to the rise in the liquid temperature of the aerosol source. In the present embodiment, the preheating time LT0 has a fixed value determined in advance.

As a result, aerosol can be generated immediately after the start of the main-heating time LT11, and consequently, the total amount of aerosol generated within the main-heating time LT11 can be increased.

As illustrated in FIG. 3B, the time from the start of the main-heating time LT11 until the temperature of the aerosol source reaches the boiling point is TD1 without the use of the preheating, but can be shortened to TD2 (<TD1) with the use of the preheating.

Accordingly, if the main-heating time LT11 has the same length as that without the use of the preheating, a larger amount of aerosol can be generated with the use of the preheating.

The temperature of the heater 211 rises with the start of supply of electric power and falls with the stop of supply of electric power. The temperature of the heater 211 in the main-heating time rises to the boiling point of the aerosol or higher with the start of supply of electric power, and falls to the boiling point of the aerosol or lower with the stop of supply of electric power.

In the present embodiment, the main-heating time LT11 is associated with the inhalation of the aerosol generation device 1 (see FIG. 1) by the user. That is, the main-heating times LT1 and LT11 start in response to the start of inhalation of the aerosol, and the main-heating times LT1 and LT11 end in response to the end of inhalation of the aerosol.

In the present embodiment, furthermore, it is assumed that the time for supplying electric power to the heater 211 is substantially the same as the time for generating an aerosol from the liquid guide 212.

More exactly, the electric power immediately after the start of supply is consumed to increase the temperature of the aerosol source held in the liquid guide 212. For this reason, a time difference occurs until the generation of aerosol is started after the liquid temperature of the aerosol source reaches the boiling point.

In FIGS. 3A and 3B, the main-heating time LT11 with the use of the preheating is shorter than the main-heating time LT1 without the use of the preheating. This is to make the amount of aerosol generated during the main-heating time LT1 equal to the amount of aerosol generated during the main-heating time LT11.

In other words, when the amount of generated aerosol is controlled to be the same as that without the preheating, the main-heating time LT11 with the use of the preheating can be made shorter than the main-heating time LT1 without the preheating.

One of the reasons why generation of aerosol is promoted by the preheating is that the viscosity of the aerosol source at the start of the main-heating time LT11 is lower than that without the use of the preheating. As the viscosity of the aerosol source decreases, the liquid feed rate for the liquid guide 212 increases, and consequently, the amount of supplied liquid increases.

As the preheating time LT0 increases, the amount of electric power consumed also increases accordingly. It is therefore desirable to set the length of the preheating time LT0 in consideration of the balance with the amount of electric power consumed in the main-heating time LT11.

### <Details of Control>

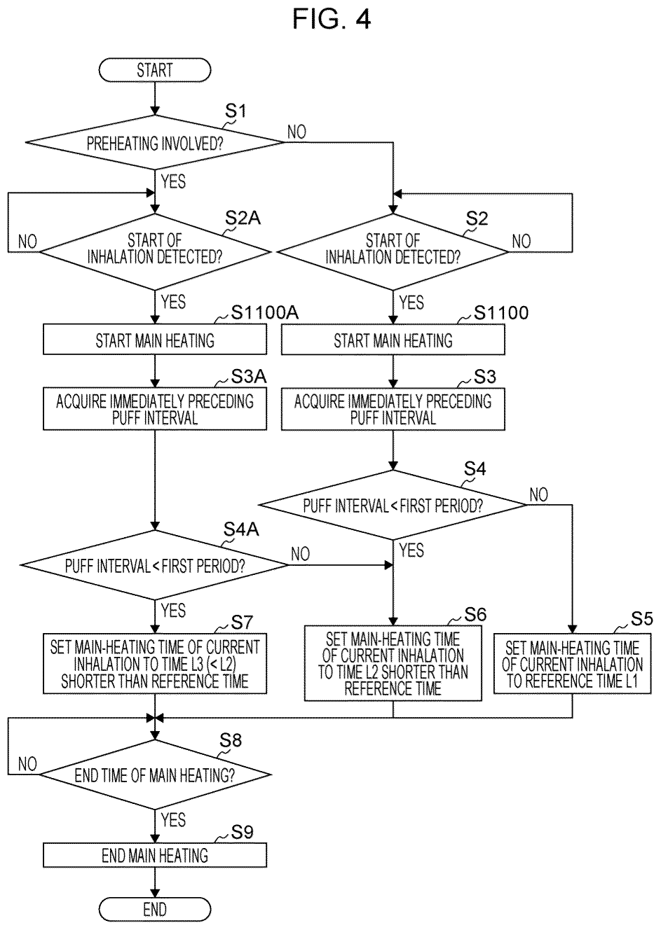

FIG. 4 is a flowchart illustrating an example of control of the main-heating time by the controller 117 (see FIG. 2) used in Embodiment 1. The control by the controller 117 is implemented through execution of a program. Thus, the controller 117 is one form of a computer. In FIG. 4, symbol S is used to represent a step.

First, the controller 117 determines whether the preheating is involved (step 1). That is, the controller 117 determines whether a preheating mode is on or off.

In other words, the aerosol generation device 1 according to the present embodiment has the preheating mode, and the user selects whether to turn on or off the preheating mode for use. For example, the preheating mode may be turned on or off by a specific operation performed on the power button 11 (see FIG. 1) or by an instruction from a Bluetooth (registered trademark) or USB (=Universal Serial Bus) connected external device such as smartphone.

Alternatively, the aerosol generation device 1 may be provided with a button dedicated to turning on or off the preheating mode.

If a negative result is obtained in step 1 (i.e., if the preheating mode is off), the controller 117 determines whether the puff sensor 112 (see FIG. 2) has detected the start of inhalation (step 2).

If the start of inhalation of the aerosol by the user is not detected, the controller 117 obtains a negative result in step 2. The controller 117 repeats the determination of step 2 while a negative result is obtained in step 2.

On the other hand, if the start of inhalation of the aerosol by the user is detected, the controller 117 obtains a positive result in step 2. If a positive result is obtained in step 2, the controller 117 starts the main heating (step 1100), and then acquires the immediately preceding puff interval (step 3).

In the present embodiment, the immediately preceding puff interval is given by the time period from the end of the immediately preceding inhalation (puff) to the start of the current inhalation (puff). The puff interval may be measured by, for example, a timer, or may be calculated as a difference between the end time of the immediately preceding inhalation and the start time of the current inhalation. The time is acquired from, for example, a timer incorporated in the controller 117, an integrated circuit that implements a timer function, or the like.

When the puff interval is acquired, the controller 117 determines whether the puff interval is shorter than a first period (step 4).

The first period is set by the balance between the capacity of the liquid guide 212 to supply the aerosol source and the period of time during which drying up is likely to occur. In the present embodiment, the first period is, for example, 10 seconds. It should be noted that this value is an example.

If the puff interval is equal to or longer than the first period, the controller 117 obtains a negative result in step 4. In this case, the controller 117 sets the main-heating time LT1 of the current inhalation to a reference time L1 (step 5). The reference time L1, as used here, is an example of a second period. In the present embodiment, for example, 2.4 seconds is used as the reference time. It should be noted that this value is an example of the reference time L1. The reference time L1 is set to a time over which no drying up occurs due to inhalation of the aerosol by an expected standard user when the puff interval is longer than a threshold.

On the other hand, if the puff interval is shorter than the first period, the controller 117 obtains a positive result in step 4. This case is referred to as “short puff”.

The short puff refers to a state in which the puff interval is shorter than the first period. At this time, the controller 117 sets the main-heating time LT1 of the current inhalation to a time L2 shorter than the reference time (step 6). In the present embodiment, only the main-heating time LT1 is shortened, and the voltage value and the current value to be supplied to the heater 211 remain the same regardless of the difference in puff interval.

In the present embodiment, for example, 1.7 seconds is used as the time L2. It should be noted that this value is an example of the main-heating time LT1 for the short puff. As the time L2 is shorter, the drying-up phenomenon in which no aerosol is generated even by heating the aerosol source is less likely to occur.

After the main-heating time LT1 is set in step 5 or step 6, the controller 117 determines whether the end time of the main heating is reached (step 8).

In the present embodiment, the main heating ends in response to, for example, the end of the set main-heating time LT1, the end of inhalation of the aerosol by the user, or forced termination. Accordingly, even if the set main-heating time LT1 remains, the supply of electric power to the heater 211 is terminated if the end of the main heating is determined. The elapse of the main-heating time LT1 is monitored using the elapsed time from the start of supply of electric power to the heater 211.

The forced termination may be operated by, for example, using long-term pressing of the power button 11 (see FIG. 1). The long-term pressing of the power button 11 means that the power button 11 is continuously pressed for a predetermined time or longer. For example, when the power button 11 is pressed and held down for three seconds or longer, the controller 117 determines that a long-term pressing operation has been performed.

The controller 117 repeats the determination of step 8 while a negative result is obtained in step 8. During this time period, the supply of electric power to the heater 211 is continued.

On the other hand, if a positive result is obtained in step 8, the controller 117 ends the main heating (step 9). That is, the supply of electric power to the heater 211 stops.

Thus, one cycle of inhalation ends.

If a short puff is detected in the use of the preheating, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

On the other hand, if a positive result is obtained in step 1 (i.e., if the preheating mode is on), the controller 117 also determines whether the immediately preceding puff interval is a short puff, and sets the main-heating time LT11 according to the result of the determination.

First, the controller 117 determines whether the puff sensor 112 has detected the start of inhalation (step 2A).

If the start of inhalation of the aerosol by the user is not detected, the controller 117 obtains a negative result in step 2A. The controller 117 repeats the determination of step 2A while a negative result is obtained in step 2A.

On the other hand, if the start of inhalation of the aerosol by the user is detected, the controller 117 obtains a positive result in step 2A. If a positive result is obtained in step 2A, the controller 117 starts the main heating (step 1100A) after the end of the preheating. Subsequently, the controller 117 acquires the immediately preceding puff interval (step 3A). The preheating may be started, for example, at the point in time when a predetermined operation or the like performed on the power button 11 is detected.

When the puff interval is acquired, the controller 117 determines whether the puff interval is shorter than the first period (step 4A). The threshold used for the determination of step 4A may be different from that for step 4. For example, the threshold used for the determination of step 4A may be smaller than the threshold used for the determination of step 4.

If the puff interval is equal to or longer than the first period, the controller 117 obtains a negative result in step 4A. In this case, the controller 117 sets the main-heating time LT11 of the current inhalation to the time L2 shorter than the reference time (step 6). That is, the main-heating time LT11 with the use of the preheating is made shorter than the main-heating time LT1 without the use of the preheating even if the puff intervals are the same. This prevents drying up, which is peculiar to the preheating. The main-heating time set when a negative result is obtained in step 4A is desirably shorter than the reference time L1, and need not be L2.

In the present embodiment, the main-heating time LT11 in a case where no short puff is detected in a situation where the preheating is used (i.e., in a case where a negative result is obtained in step 4A) and the main-heating time LT1 in a case where a short puff is detected in a situation where the preheating is not used (i.e., in a case where a positive result is obtained in step 4) are set to be the same, namely, the time L2. However, but these times need not be the same.

For example, the main-heating time LT11 in a case where a negative result is obtained in step 4A may be set to a value shorter than the main-heating time LT1 in a case where a positive result is obtained in step 4.

On the other hand, if a positive result is obtained in step 4A, the controller 117 sets the main-heating time LT11 of the current inhalation to a time L3 (<L2) shorter than the reference time L1 (step 7). As a result, even in a situation where the liquid temperature at the start of the main heating is higher than expected due to the short puff, the occurrence of drying up can be avoided in advance.

After the main-heating time LT11 is set in step 6 or step 7, the controller 117 sequentially executes the processing of step 8 and step 9, and completes one cycle of inhalation.

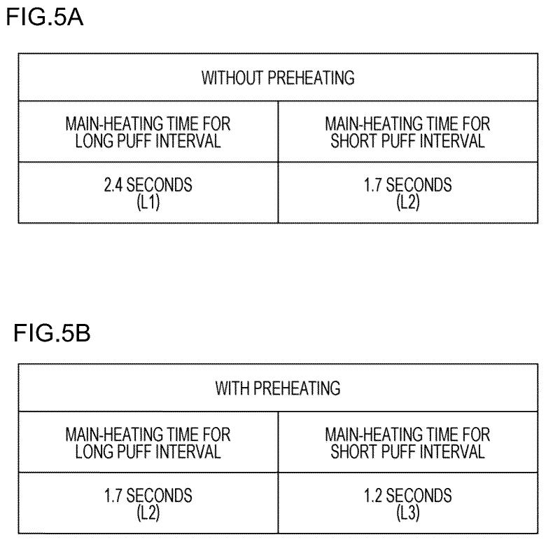

FIGS. 5A and 5B are diagrams illustrating an example of setting of the main-heating time according to the presence or absence of preheating and the length of the puff interval. FIG. 5A illustrates an example of setting of the main-heating time LT1 without the preheating, and FIG. 5B illustrates an example of setting of the main-heating time LT11 with the preheating.

As illustrated in FIG. 5A, in the absence of preheating, the main-heating time LT1 (i.e., L1) for a long puff interval is 2.4 seconds, and the main-heating time LT1 (i.e., L2) for a short puff interval is 1.7 seconds.

As illustrated in FIG. 5B, with the use of preheating, the main-heating time LT11 (i.e., L2) for a long puff interval is 1.7 seconds, and the main-heating time LT11 (i.e., L3) for a short puff interval is 1.2 seconds.

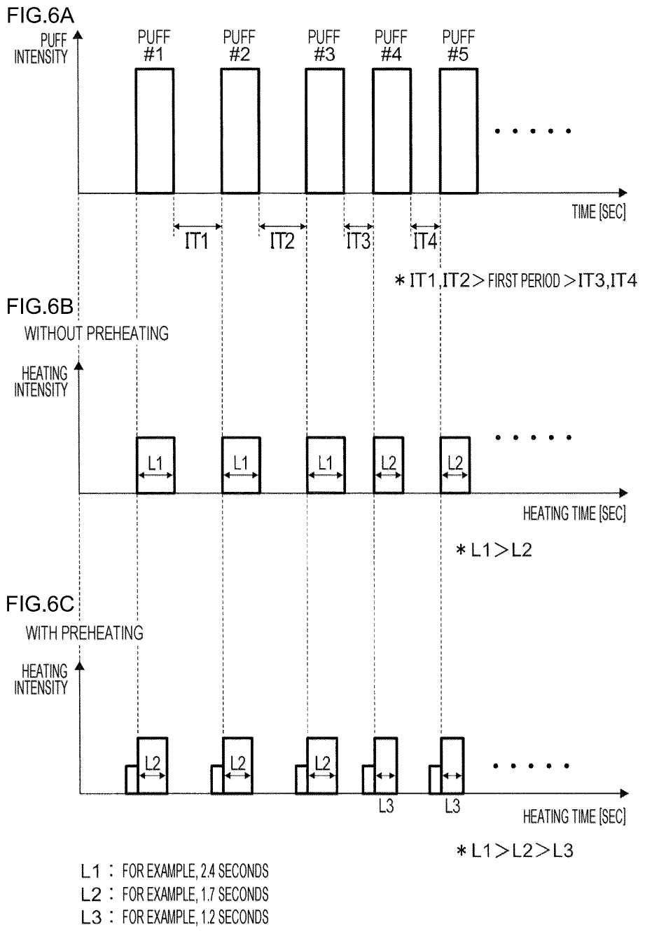

FIGS. 6A to 6C are diagrams illustrating a relationship between a puff interval and a set main-heating time in Embodiment 1. FIG. 6A illustrates example timings of inhalation (puff), FIG. 6B illustrates an example of setting of the main-heating time without the preheating, and FIG. 6C illustrates an example of setting of the main-heating time with the preheating. In FIG. 6A, the vertical axis represents puff intensity. In FIGS. 6B and 6C, the vertical axis represents heating intensity. In FIGS. 6A to 6C, the horizontal axis represents time. The heating intensity is the amount of electric power and is given by the product of a voltage value and a current value supplied to the heater 211.

In FIG. 6A, the number of inhalations (puffs) is five.

In FIG. 6A, the interval between the first puff and the second puff is IT1, the interval between the second puff and the third puff is IT2, the interval between the third puff and the fourth puff is IT3, and the interval between the fourth puff and the fifth puff is IT4. In this example, the third and fourth puff intervals IT3 and IT4 are shorter than the first period. That is, the third and fourth puff intervals are determined to be short puffs. Accordingly, the first and second puff intervals IT1 and IT2 are not short puffs.

In FIG. 6B corresponding to the absence of preheating, accordingly, the main-heating times of the first puff, the second puff, and the third puff are set to the reference time L1, whereas the main-heating times of the fourth puff and the fifth puff are set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff. The same applies to the fifth puff.

In the sixth and subsequent puffs, if the immediately preceding puff interval is longer than the threshold, the main-heating time LT1 of the current inhalation is set to the reference time L1 again.

On the other hand, in FIG. 6C corresponding to the presence of preheating, the main-heating times LT11 of the first puff, the second puff, and the third puff are set to L2 shorter than the reference time L1, whereas the main-heating times LT11 of the fourth puff and the fifth puff are set to the time L3 (<L2) shorter than the reference time L1.

As a result, even if the puff interval until the start of the fourth puff is short and the amount of supply of the aerosol source to be supplied to the heater 211 until the start of inhalation is small, the main-heating time LT11 is further shortened. Thus, no drying up occurs during the fourth puff. The same applies to the fifth puff. The use of the preheating provides high generation efficiency of the aerosol source. Thus, even if the main-heating time LT11 is shortened, the user does not recognize the shortage of the aerosol.

In FIGS. 6B and 6C, the time period of inhalation of the aerosol by the user and the heating time of the heater 211 (see FIG. 2) are made to match within a preset main-heating time. Alternatively, the main heating may be started in response to a turn-on operation of the power button 11 (see FIG. 1), or the main heating may be continued until the main-heating time elapses even after the user finishes inhalation.

In these cases, the puff interval does not coincide with the time during which the main heating is at a standstill. However, as in the example control described above, drying up can be effectively prevented or reduced during a short puff.

### Embodiment 2

In Embodiment 2, the puff interval is defined as a period during which the supply of electric power to the heater 211 (see FIG. 2) is at a standstill.

In the present embodiment, the supply of electric power to the heater 211 is started in response to a predetermined operation performed on the power button 11 (see FIG. 1), and the supply of electric power to the heater 211 is ended in response to the elapse of a preset main-heating time, or forced termination of the supply of electric power or any other operation by the user.

Alternatively, as in Embodiment 1, electric power may be supplied to the heater 211 in accordance with inhalation of the aerosol by the user.

The other configurations of the aerosol generation device 1 (see FIG. 1) in the present embodiment are the same as those in Embodiment 1. That is, the aerosol generation device 1 has the same external configuration and internal configuration as those in Embodiment 1.

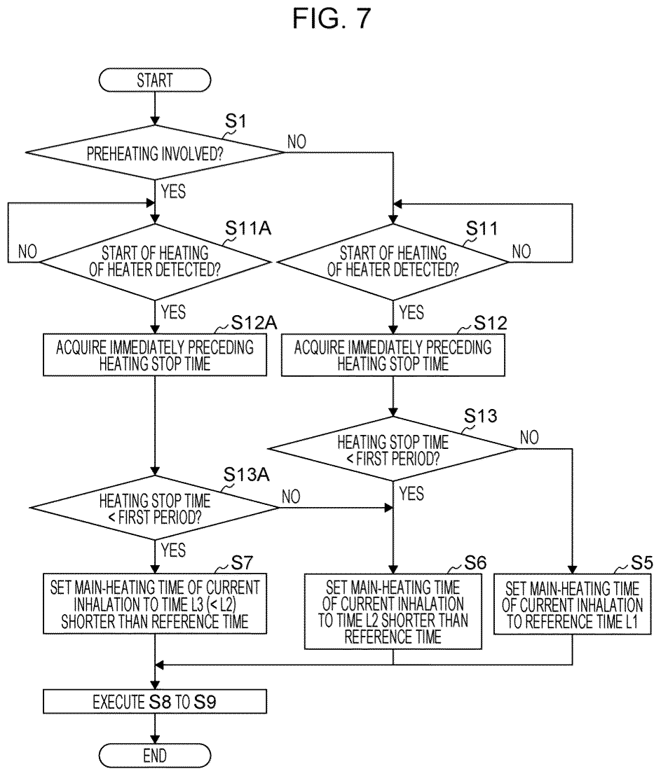

FIG. 7 is a flowchart illustrating an example of control of the main-heating time by the controller 117 (see FIG. 2) used in Embodiment 2. In FIG. 7, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether the start of heating of the heater 211 is detected (step 11). That is, it is determined whether the main heating has started.

The start of heating of the heater 211 is detected by, for example, a turn-on operation of the power button 11 (see FIG. 1), start of inhalation by the user, or the like.

The turn-on operation, as used here, is an operation of giving an instruction to start supplying electric power to the heater 211. Examples of such an operation include the long-term pressing of the power button 11.

The start of heating of the aerosol source using the heater 211 may be detected by detection of a current for the main heating, detection of a voltage for the main heating, a change in the resistance value of the heater 211, a rise in the temperature of the liquid guide 212, or the like.

If the start of heating of the heater 211 is not detected, the controller 117 obtains a negative result in step 11. The controller 117 repeats the determination of step 11 while a negative result is obtained in step 11.

On the other hand, if the start of heating of the heater 211 is detected, the controller 117 obtains a positive result in step 11. If a positive result is obtained in step 11, the controller 117 acquires the immediately preceding heating stop time (step 12). The immediately preceding heating stop time is given by the elapsed time from the end of heating in the previous inhalation to the start of heating in the current inhalation. Note that the heating stop time refers to a period other than the main heating. Thus, the time during which the preheating is performed is also included in the heating stop time.

The heating stop time may be measured by, for example, a timer, or may be calculated as a difference between the time at which the immediately preceding heating operation ends and the time at which the current heating operation starts.

When the heating stop time is acquired, the controller 117 determines whether the heating stop time is shorter than the first period (step 13).

The first period, as used here, is set by the balance between the capacity of the liquid guide 212 to supply the aerosol source and the period of time during which drying up is likely to occur, as in Embodiment 1. Also in the present embodiment, the first period is, for example, 10 seconds. It should be noted that this value is an example. The first period is not an absolute value.

If the heating stop time is equal to or longer than the first period, the controller 117 obtains a negative result in step 13. In this case, the controller 117 sets the main-heating time of the current inhalation to the reference time L1 (step 5).

On the other hand, if the heating stop time is shorter than the first period, that is, if the condition for a short puff is satisfied, the controller 117 sets the main-heating time of the current inhalation to the time L2 shorter than the reference time (step 6).

After the main-heating time LT1 is set in step 5 or step 6, the controller 117 sequentially executes step 8 and step 9, and completes one cycle of inhalation.

On the other hand, if a positive result is obtained in step 1 (i.e., if the preheating mode is on), the controller 117 also determines whether the start of heating of the heater 211 is detected (step 11A). That is, the controller 117 determines whether the preheating has ended and the main heating has started.

If the start of heating of the heater 211 is not detected, the controller 117 obtains a negative result in step 11A. The controller 117 repeats the determination of step 11A while a negative result is obtained in step 11A.

On the other hand, if the start of heating of the heater 211 is detected, the controller 117 obtains a positive result in step 11A. If a positive result is obtained in step 11A, the controller 117 acquires the immediately preceding heating stop time (step 12A).

When the heating stop time is acquired, the controller 117 determines whether the heating stop time is shorter than the first period (step 13A). The threshold used for the determination of step 13A may be different from that for step 13. For example, the threshold used for the determination of step 13A may be smaller than the threshold used for the determination of step 13.

If the heating stop time is equal to or longer than the first period, the controller 117 obtains a negative result in step 13A. In this case, the controller 117 sets the main-heating time of the current inhalation to the time L2 shorter than the reference time L1 (step 6). The main-heating time set when a negative result is obtained in step 3A is desirably shorter than the reference time L1, and need not be L2.

On the other hand, if the heating stop time is shorter than the first period, that is, if the condition for a short puff is satisfied, the controller 117 sets the main-heating time of the current inhalation to the time L3 (<L2) shorter than the reference time (step 7).

After the main-heating time LT11 is set in step 6 or step 7, the controller 117 sequentially executes step 8 and step 9, and completes one cycle of inhalation.

As described above, the controller 117 in the present embodiment detects the occurrence of a short puff, which causes drying up, with a focus on the heating stop time, which is a time period during which the generation of aerosol stops. Thus, the occurrence of drying up can be effectively prevented or reduced.

Also in the present embodiment, if a short puff is detected in the use of the preheating, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

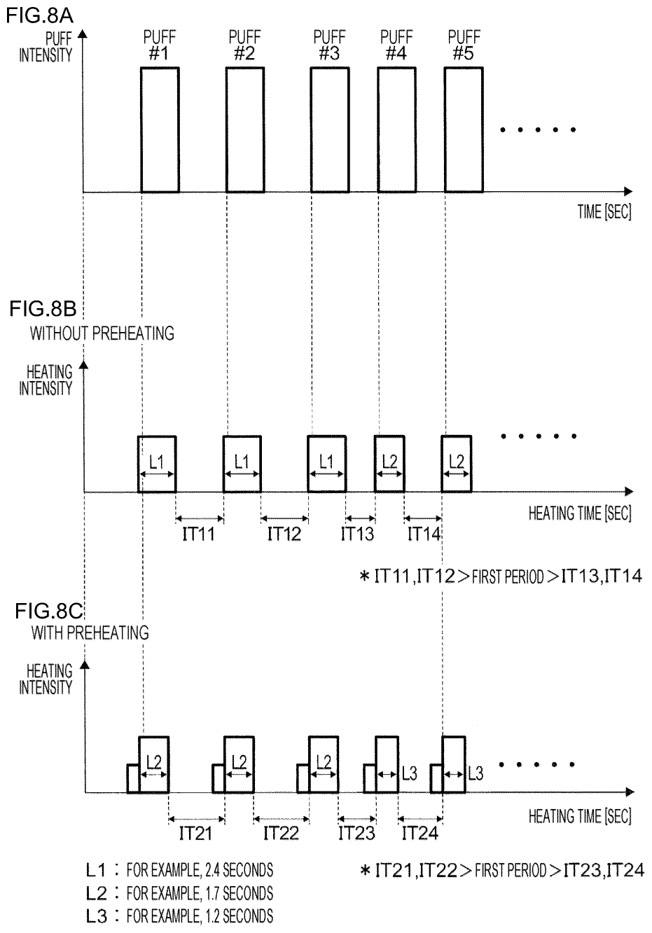

FIGS. 8A to 8C are diagrams illustrating a relationship between a puff interval and a set main-heating time in Embodiment 2. FIG. 8A illustrates example timings of inhalation (puff), FIG. 8B illustrates an example of setting of the main-heating time LT1 without the preheating, and FIG. 8C illustrates an example of setting of the main-heating time LT11 with the preheating. In FIG. 8A, the vertical axis represents puff intensity. In FIGS. 8B and 8C, the vertical axis represents heating intensity. In FIGS. 8A to 8C, the horizontal axis represents time.

FIG. 8A illustrates a case where the period during which the heater 211 is heated does not coincide with the period during which the user inhales. That is, FIG. 8A illustrates a case where heating of the heater 211 starts in response to, for example, a turn-on operation of the power button 11 and the heating ends after the main-heating time set in advance elapses. Alternatively, as described above, the time during which the heater 211 is heated can coincide with the time during which the user inhales the aerosol.

Also in FIG. 8A, the number of inhalations (puffs) is five.

In FIG. 8B corresponding to the absence of preheating, the heating stop time that gives the interval between the first puff and the second puff is IT11, the heating stop time that gives the interval between the second puff and the third puff is IT12, the heating stop time that gives the interval between the third puff and the fourth puff is IT13, and the heating stop time that gives the interval between the fourth puff and the fifth puff is IT14. In this example, the third and fourth puff intervals are shorter than the first period. That is, the third and fourth puff intervals are determined to be short puffs.

In the absence of preheating, accordingly, the main-heating times LT1 of the first puff, the second puff, and the third puff are set to the reference time L1, whereas the main-heating times LT1 of the fourth puff and the fifth puff are set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff. The same applies to the fifth puff.

In the sixth and subsequent puffs, if the immediately preceding puff interval is longer than the threshold, the main-heating time LT1 of the current inhalation is set to the reference time L1 again.

By contrast, in FIG. 8C corresponding to the presence of preheating, the heating stop time that gives the interval between the first puff and the second puff is IT21, the heating stop time that gives the interval between the second puff and the third puff is IT22, the heating stop time that gives the interval between the third puff and the fourth puff is IT23, and the heating stop time that gives the interval between the fourth puff and the fifth puff is IT24. In this example, the third and fourth puff intervals are shorter than the first period. That is, the third and fourth puff intervals are determined to be short puffs.

Accordingly, the main-heating times LT11 of the first puff, the second puff, and the third puff are set to L2 shorter than the reference time L1, whereas the main-heating times LT11 of the fourth puff and the fifth puff are set to the time L3 (<L2) shorter than the reference time L1.

As a result, even if the puff interval until the start of the fourth puff is short and the amount of supply of the aerosol source to be supplied to the heater 211 until the start of inhalation is small, the main-heating time LT11 is further shortened. Thus, no drying up occurs during the fourth puff. The same applies to the fifth puff.

### Embodiment 3

In Embodiment 3, the puff interval is defined as an elapsed time from the stop of the supply of electric power to the heater 211 (see FIG. 2) for the immediately preceding inhalation to the start of the current inhalation. In other words, control corresponding to the combined control of Embodiment 1 and Embodiment 2 is provided.

The other configurations of the aerosol generation device 1 (see FIG. 1) in the present embodiment are the same as those in Embodiment 1. That is, the aerosol generation device 1 has the same external configuration and internal configuration as those in Embodiment 1.

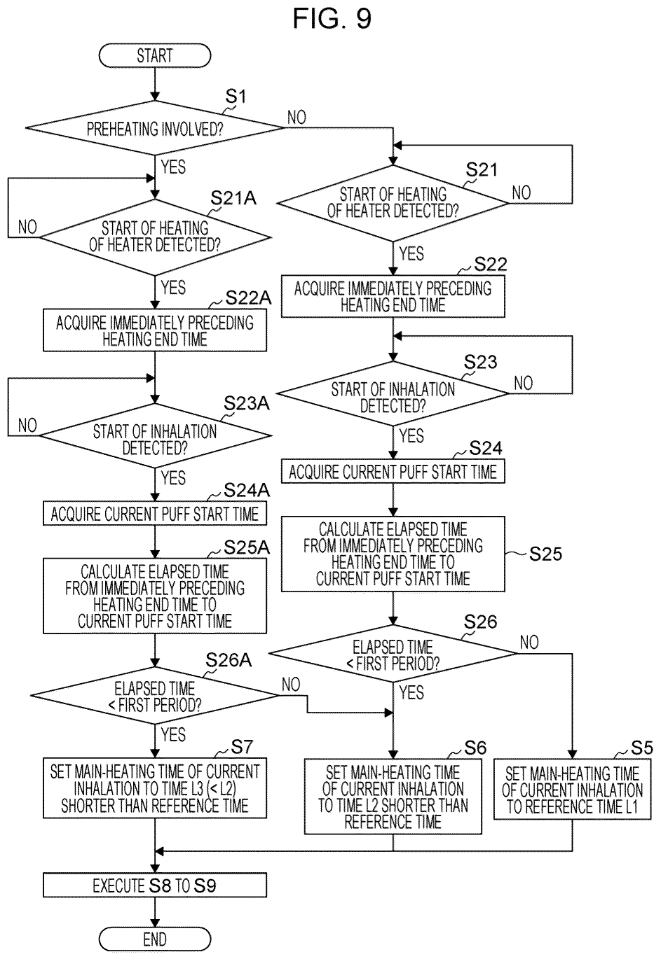

FIG. 9 is a flowchart illustrating an example of control of the main-heating time by the controller 117 (see FIG. 2) used in Embodiment 3. In FIG. 9, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether the start of heating of the heater 211 is detected (step 21). That is, it is determined whether the main heating has started.

If the start of heating of the heater 211 is not detected, the controller 117 obtains a negative result in step 21. The controller 117 repeats the determination of step 21 while a negative result is obtained in step 21.

On the other hand, if the start of heating of the heater 211 is detected, the controller 117 obtains a positive result in step 21. If a positive result is obtained in step 21, the controller 117 acquires the immediately preceding heating end time (step 22). In the present embodiment, the heating end time refers to the time at which the main heating ends.

Then, the controller 117 determines whether the puff sensor 112 has detected the start of inhalation (step 23).

If the start of inhalation of the aerosol by the user is not detected, the controller 117 obtains a negative result in step 23. The controller 117 repeats the determination of step 23 while a negative result is obtained in step 23. Even if a negative result is obtained in step 23, the controller 117 forcibly terminates the heating when a predetermined condition is satisfied. The predetermined condition includes, for example, the detection of no puff within a predetermined time.

On the other hand, if the start of inhalation of the aerosol by the user is detected, the controller 117 obtains a positive result in step 23. If a positive result is obtained in step 23, the controller 117 acquires the current puff start time (step 24). The current puff start time is the time at which a positive result is obtained in step 23.

Then, the controller 117 calculates the elapsed time from the immediately preceding heating end time to the current puff start time (step 25).

When the elapsed time is calculated, the controller 117 determines whether the elapsed time is shorter than the first period (step 26).

If the elapsed time is equal to or longer than the first period, the controller 117 obtains a negative result in step 26. In this case, the controller 117 sets the main-heating time of the current inhalation to the reference time L1 (step 5).

On the other hand, if the elapsed time is shorter than the threshold, the controller 117 obtains a positive result in step 26. In this case, the controller 117 sets the main-heating time of the current inhalation to the time L2 shorter than the reference time (step 6).

After the main-heating time LT1 is set in step 5 or step 6, the controller 117 sequentially executes step 8 and step 9, and completes one cycle of inhalation.

On the other hand, if a positive result is obtained in step 1 (i.e., if the preheating mode is on), the controller 117 also determines whether the start of heating of the heater 211 is detected (step 21A). That is, the controller 117 determines whether the preheating has ended and the main heating has started.

If the start of heating of the heater 211 is not detected, the controller 117 obtains a negative result in step 21A. The controller 117 repeats the determination of step 21A while a negative result is obtained in step 21A.

On the other hand, if the start of heating of the heater 211 is detected, the controller 117 obtains a positive result in step 21A. If a positive result is obtained in step 21A, the controller 117 acquires the immediately preceding heating end time (step 22A).

Then, the controller 117 determines whether the puff sensor 112 has detected the start of inhalation (step 23A).

If the start of inhalation of the aerosol by the user is not detected, the controller 117 obtains a negative result in step 23A. The controller 117 repeats the determination of step 23A while a negative result is obtained in step 23A.

On the other hand, if the start of inhalation of the aerosol by the user is detected, the controller 117 obtains a positive result in step 23A. If a positive result is obtained in step 23A, the controller 117 acquires the current puff start time (step 24A). The current puff start time is the time at which a positive result is obtained in step 23A.

Then, the controller 117 calculates the elapsed time from the immediately preceding heating end time to the current puff start time (step 25A).

When the elapsed time is calculated, the controller 117 determines whether the elapsed time is shorter than the first period (step 26A). The threshold used for the determination of step 26A may be different from that for step 26. For example, the threshold used for the determination of step 26A may be smaller than the threshold used for the determination of step 26.

If the elapsed time is equal to or longer than the first period, the controller 117 obtains a negative result in step 26A. In this case, the controller 117 sets the main-heating time of the current inhalation to the time L2 shorter than the reference time (step 6). The main-heating time set when a negative result is obtained in step 26A is desirably shorter than the reference time L1, and need not be L2.

On the other hand, if the elapsed time is shorter than the first period, that is, if the condition for a short puff is satisfied, the controller 117 sets the main-heating time of the current inhalation to the time L3 (<L2) shorter than the reference time (step 7).

After the main-heating time is set in step 6 or step 7, the controller 117 sequentially executes step 8 and step 9, and completes one cycle of inhalation.

As described above, the controller 117 in the present embodiment detects the occurrence of a short puff, which causes drying up, with a focus on the elapsed time from the time at which the immediately preceding heating ends to the start of the current inhalation of the aerosol. Thus, the occurrence of drying up can be effectively prevented or reduced.

Also in the present embodiment, if a short puff is detected in the use of the preheating, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

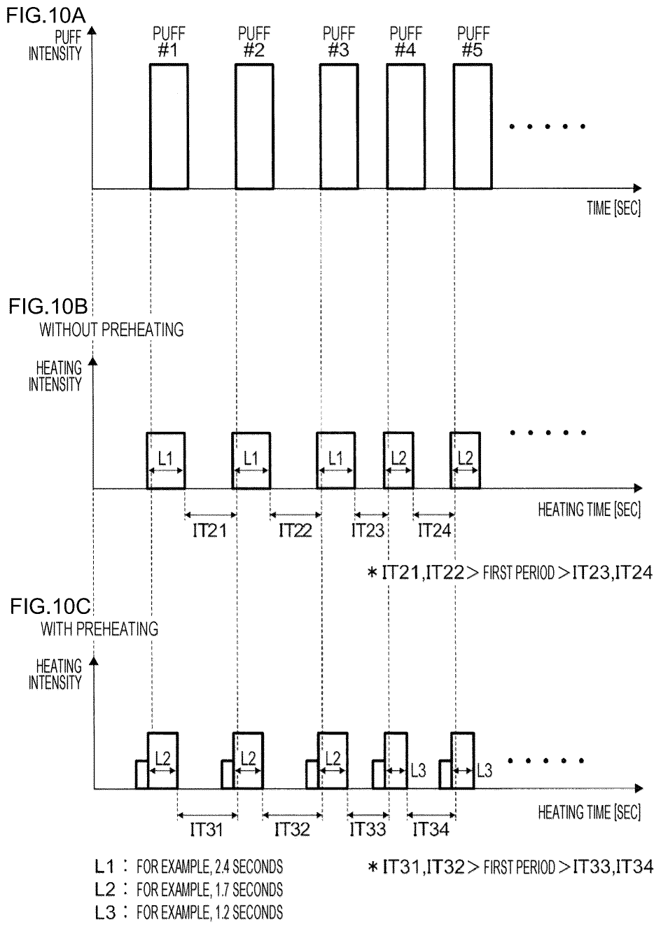

FIGS. 10A to 10C are diagrams illustrating a relationship between a puff interval and a set main-heating time in Embodiment 3. FIG. 10A illustrates example timings of inhalation (puff), FIG. 10B illustrates an example of setting of the main-heating time without the preheating, and FIG. 10C illustrates an example of setting of the main-heating time with the preheating. In FIG. 10A, the vertical axis represents puff intensity. In FIGS. 10B and 10C, the vertical axis represents heating intensity. In FIGS. 10A to 10c, the horizontal axis represents time.

FIGS. 10A to 10C also illustrate a case where the period during which the heater 211 is heated does not coincide with the period during which the user inhales. That is, FIGS. 10A to 10C illustrate a case where heating of the heater 211 starts in response to a turn-on operation of the power button 11 and the heating ends after the main-heating time set in advance elapses. Alternatively, as described above, the time during which the heater 211 is heated can coincide with the time during which the user inhales the aerosol.

Also in FIG. 10A, the number of inhalations (puffs) is five.

In FIG. 10B corresponding to the absence of preheating, the elapsed time that gives the interval between the first puff and the second puff is IT21, the elapsed time that gives the interval between the second puff and the third puff is IT22, the elapsed time that gives the interval between the third puff and the fourth puff is IT23, and the elapsed time that gives the interval between the fourth puff and the fifth puff is IT24. In this example, the third and fourth puff intervals are shorter than the first period. That is, the third and fourth puff intervals are determined to be short puffs.

Accordingly, the main-heating times LT1 of the first puff, the second puff, and the third puff are set to the reference time L1, whereas the main-heating times LT1 of the fourth puff and the fifth puff are set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff. The same applies to the fifth puff.

In the sixth and subsequent puffs, if the immediately preceding puff interval is longer than the threshold, the main-heating time LT1 of the current inhalation is set to the reference time L1 again.

By contrast, in FIG. 10C corresponding to the presence of preheating, the elapsed time that gives the interval between the first puff and the second puff is IT31, the elapsed time that gives the interval between the second puff and the third puff is IT32, the elapsed time that gives the interval between the third puff and the fourth puff is IT33, and the elapsed time that gives the interval between the fourth puff and the fifth puff is IT34. In this example, the third and fourth puff intervals are shorter than the first period. That is, the third and fourth puff intervals are determined to be short puffs.

Accordingly, the main-heating times LT11 of the first puff, the second puff, and the third puff are set to L2 shorter than the reference time L1, whereas the main-heating times LT11 of the fourth puff and the fifth puff are set to the time L3 (<L2) shorter than the reference time L1.

As a result, even if the puff interval until the start of the fourth puff is short and the amount of supply of the aerosol source to be supplied to the heater 211 until the start of inhalation is small, the main-heating time LT11 is further shortened. Thus, no drying up occurs during the fourth puff. The same applies to the fifth puff.

### Embodiment 4

In Embodiment 4, the puff interval is defined as a period from a turn-on operation to a turn-off operation of the power button 11 (see FIG. 1). Also in the present embodiment, the supply of electric power to the heater 211 is started in response to a turn-on operation of the power button 11, and the supply of electric power to the heater 211 is ended in response to the elapse of a preset main-heating time or a turn-off operation by the user.

In the present embodiment, the end of the supply of electric power in response to the elapse of a preset main-heating time is regarded as the end of the supply of electric power in response to a turn-off operation by the user.

The other configurations of the aerosol generation device 1 (see FIG. 1) in the present embodiment are the same as those in Embodiment 1. That is, the aerosol generation device 1 has the same external configuration and internal configuration as those in Embodiment 1.

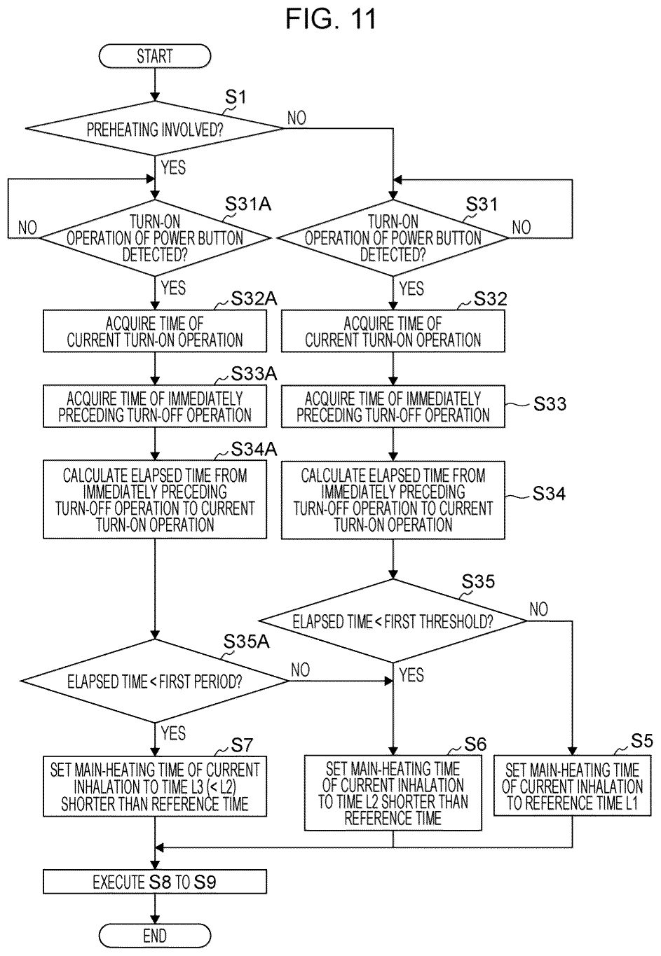

FIG. 11 is a flowchart illustrating an example of control of the main-heating time by the controller 117 (see FIG. 2) used in Embodiment 4. In FIG. 11, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether a turn-on operation of the power button 11 is detected (step 31). That is, it is determined whether the main heating has started.

If a turn-on operation of the power button 11 is not detected, the controller 117 obtains a negative result in step 31. The controller 117 repeats the determination of step 31 while a negative result is obtained in step 31.

On the other hand, if a turn-on operation of the power button 11 is detected, the controller 117 obtains a positive result in step 31. If a positive result is obtained in step 31, the controller 117 acquires the time of the current turn-on operation (step 32).

When the time of the turn-on operation is acquired, the controller 117 acquires the time of the immediately preceding turn-off operation (step 33).

Then, the controller 117 calculates the elapsed time from the immediately preceding turn-off operation to the current turn-on operation (step 34).

When the elapsed time is calculated, the controller 117 determines whether the elapsed time is shorter than the first period (step 35).

If the elapsed time is equal to or longer than the first period, the controller 117 obtains a negative result in step 35. In this case, the controller 117 sets the main-heating time of the current inhalation to the reference time L1 (step 5).

If the elapsed time is shorter than the first period, the controller 117 obtains a positive result in step 35. In this case, the controller 117 sets the main-heating time of the current inhalation to the time L2 shorter than the reference time (step 6).

After the main-heating time is set in step 5 or step 6, the controller 117 sequentially executes step 8 and step 9, and completes one cycle.

On the other hand, if a positive result is obtained in step 1 (i.e., if the preheating mode is on), the controller 117 determines whether a turn-on operation of the power button 11 is detected (step 31A). That is, the controller 117 determines whether the preheating has ended and the main heating has started.

If a turn-on operation of the power button 11 is not detected, the controller 117 obtains a negative result in step 31A. The controller 117 repeats the determination of step 31A while a negative result is obtained in step 31A.

On the other hand, if a turn-on operation of the power button 11 is detected, the controller 117 obtains a positive result in step 31A. If a positive result is obtained in step 31A, the controller 117 acquires the time of the current turn-on operation (step 32A).

When the time of the turn-on operation is acquired, the controller 117 acquires the time of the immediately preceding turn-off operation (step 33A).

Then, the controller 117 calculates the elapsed time from the immediately preceding turn-off operation to the current turn-on operation (step 34A).

When the elapsed time is calculated, the controller 117 determines whether the elapsed time is shorter than the first period (step 35A). The threshold used for the determination of step 35A may be different from that for step 35. For example, the threshold used for the determination of step 35A may be smaller than the threshold used for the determination of step 35.

If the elapsed time is equal to or longer than the first period, the controller 117 obtains a negative result in step 35A. In this case, the controller 117 sets the main-heating time of the current inhalation to the time L2 shorter than the reference time (step 6). The main-heating time set when a negative result is obtained in step 35A is desirably shorter than the reference time L1, and need not be L2.

If the elapsed time is shorter than the first period, the controller 117 obtains a positive result in step 35A. In this case, the controller 117 sets the main-heating time of the current inhalation to the time L3 (<L2) shorter than the reference time (step 7).

After the main-heating time is set in step 6 or step 7, the controller 117 sequentially executes step 8 and step 9, and completes one cycle of inhalation.

In the present embodiment, the controller 117 detects the occurrence of a short puff, which causes drying up, based on the relationship between the first period and the elapsed time from a turn-off operation to a turn-on operation of the power button 11. Thus, the occurrence of drying up can be effectively prevented or reduced.

Also in the present embodiment, if a short puff is detected in the use of the preheating, the main-heating time is shorter than the reference time L1. Thus, the amount of electric power to be supplied to the heater 211 during one cycle of inhalation is smaller than the amount of electric power (reference value) to be supplied in the case of the reference time L1.

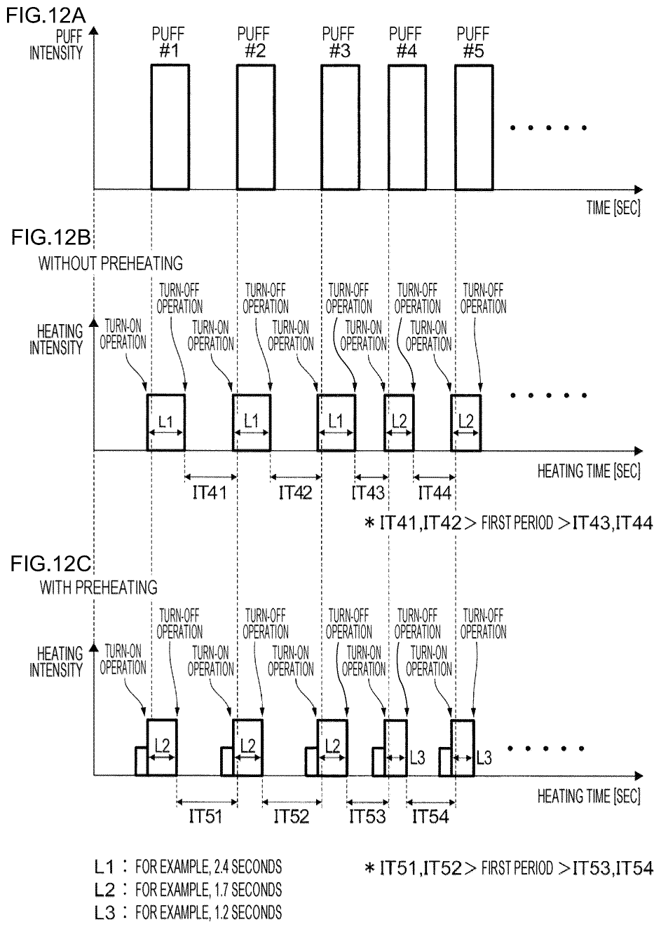

FIGS. 12A to 12C are diagrams illustrating a relationship between a puff interval and a set main-heating time in Embodiment 4. FIG. 12A illustrates example timings of inhalation (puff), FIG. 12B illustrates an example of setting of the main-heating time without the preheating, and FIG. 12C illustrates an example of setting of the main-heating time with the preheating. In FIG. 12A, the vertical axis represents puff intensity. In FIGS. 12B and 12C, the vertical axis represents heating intensity. In FIGS. 12A to 12C, the horizontal axis represents time.

FIGS. 12A to 12C also illustrate a case where the period during which the heater 211 is heated does not coincide with the period during which the user inhales. That is, FIGS. 12A to 12C illustrate a case where the user inhales the aerosol in any period within a main-heating period started in response to a turn-on operation of the power button 11.

Also in FIG. 12A, the number of inhalations (puffs) is five.

In FIG. 12B corresponding to the absence of preheating, the elapsed time that gives the interval between the first puff and the second puff is IT41, the elapsed time that gives the interval between the second puff and the third puff is IT42, the elapsed time that gives the interval between the third puff and the fourth puff is IT43, and the elapsed time that gives the interval between the fourth puff and the fifth puff is IT44. In this example, the third and fourth puff intervals are shorter than the first period. That is, the third and fourth puff intervals are determined to be short puffs.

Accordingly, the main-heating times LT1 of the first puff, the second puff, and the third puff are set to the reference time L1, whereas the main-heating times LT1 of the fourth puff and the fifth puff are set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff. The same applies to the fifth puff.

In the sixth and subsequent puffs, if the immediately preceding puff interval is longer than the threshold, the main-heating time LT1 of the current inhalation is set to the reference time L1 again.

By contrast, in FIG. 12C corresponding to the presence of preheating, the elapsed time that gives the interval between the first puff and the second puff is IT51, the elapsed time that gives the interval between the second puff and the third puff is IT52, the elapsed time that gives the interval between the third puff and the fourth puff is IT53, and the elapsed time that gives the interval between the fourth puff and the fifth puff is IT54. In this example, the third and fourth puff intervals are shorter than the first period. That is, the third and fourth puff intervals are determined to be short puffs.

Accordingly, the main-heating times LT11 of the first puff, the second puff, and the third puff are set to L2 shorter than the reference time L1, whereas the main-heating times LT11 of the fourth puff and the fifth puff are set to the time L3 (<L2) shorter than the reference time L1.

As a result, even if the puff interval until the start of the fourth puff is short and the amount of supply of the aerosol source to be supplied to the heater 211 until the start of inhalation is small, the main-heating time LT11 is further shortened. Thus, no drying up occurs during the fourth puff. The same applies to the fifth puff.

In the present embodiment, the turn-on operation and turn-off operation of the power button 11 are to be detected. Alternatively, electric power may be supplied to the heater 211 by an operation of another button or a GUI. In this case, the control operation described in the present embodiment is desirably executed in response to the detection of such an operation.

### Embodiment 5

Embodiment 5 describes an example of a method for indirectly detecting the occurrence of a short puff. As described above, when the puff interval is short, the aerosol source in the liquid guide 212 starts to be reheated before the liquid temperature of the aerosol source is sufficiently lowered. In the present embodiment, a focus is on this phenomenon.

An aerosol generation device 1 according to the present embodiment also has the same external configuration as that in Embodiment 1. However, the aerosol generation device 1 provided in the present embodiment has an internal configuration that is partially different from that in Embodiment 1.

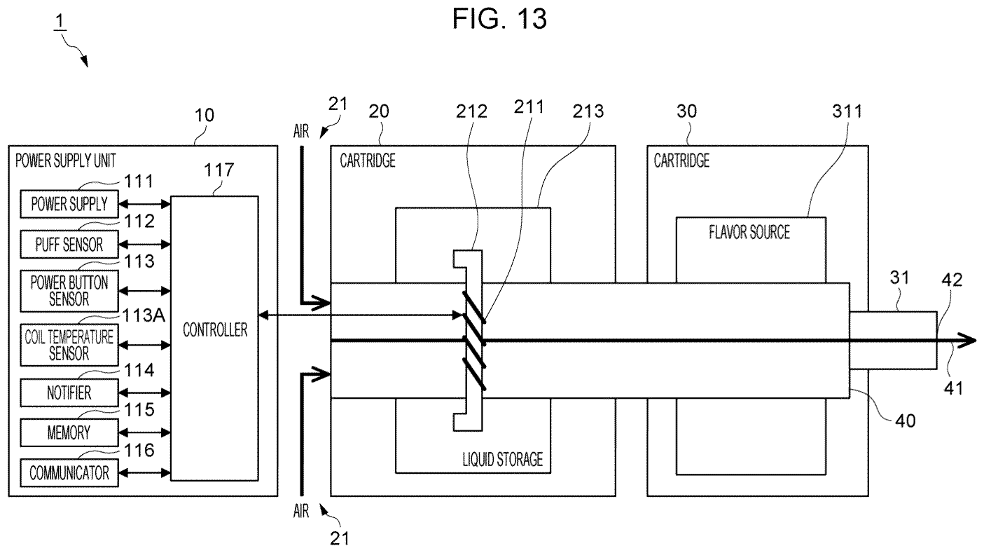

FIG. 13 is a diagram schematically illustrating an internal configuration of the aerosol generation device 1 provided in Embodiment 5. In FIG. 13, parts corresponding to those in FIG. 2 are denoted by corresponding reference numerals.

Unlike the aerosol generation device 1 illustrated in FIG. 2, the aerosol generation device 1 illustrated in FIG. 13 is provided with a coil temperature sensor 113A. The heater 211 is a coil.

For example, a thermistor is used as the coil temperature sensor 113A. The thermistor is disposed in the vicinity of the coil. The coil temperature sensor 113A is an example of a second sensor.

However, instead of the coil temperature sensor 113A, a current value flowing through the heater 211 may be measured, or a voltage appearing in a resistor connected in series to the heater 211 may be measured.

When the puff interval is short, the temperature of the heater 211 at the start of inhalation is higher and the heater 211 has a larger resistance value than when the puff interval is long. Thus, when the puff interval is short, the current is more difficult to flow than when the puff interval is long.

Accordingly, monitoring the value of the current (i.e., “current value”) flowing through the heater 211 or the value of the voltage (i.e., “voltage value”) appearing in the resistor connected in series to the heater 211 enables the detection of the temperature of the heater 211.

For example, a table in which the relationship between the current value or the voltage value is associated with the temperature of the heater 211 is prepared. In this case, the controller 117 reads the temperature corresponding to the measured current value or voltage value from the table.

For example, a conversion formula between the current value or the voltage value and the temperature of the heater 211 is prepared. In this case, the controller 117 substitutes the measured current value or voltage value into a variable to calculate the corresponding temperature.

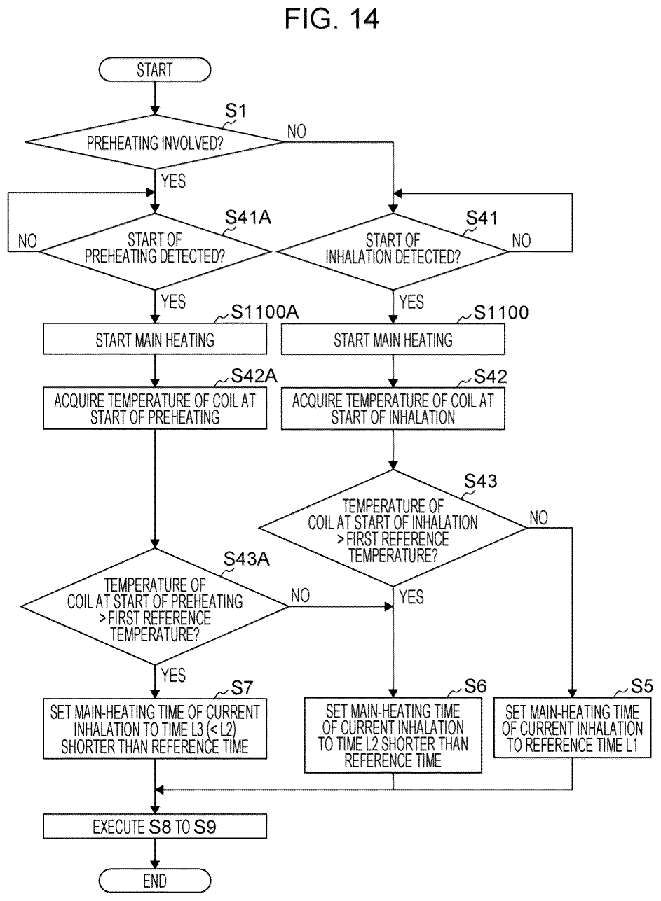

FIG. 14 is a flowchart illustrating an example of control of the main-heating time by the controller 117 (see FIG. 2) used in Embodiment 5. In FIGS. 12A to 12C, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 41).

If the start of inhalation of the aerosol by the user is not detected, the controller 117 obtains a negative result in step 41. The controller 117 repeats the determination of step 41 while a negative result is obtained in step 41.

On the other hand, if the start of inhalation of the aerosol by the user is detected, the controller 117 obtains a positive result in step 41. If a positive result is obtained in step 41, the controller 117 starts the main heating (step 1100), and then acquires the temperature of the coil at the start of inhalation (step 42). The temperature of the coil is the temperature of the heater 211.

When the temperature of the coil is acquired, the controller 117 determines whether the temperature of the coil at the start of inhalation is higher than a first reference temperature (step 43). The first reference temperature is set to an intermediate value between a temperature that appears for a short puff and a temperature that appears for a non-short puff.

If the temperature of the coil is equal to or lower than the first reference temperature, the controller 117 obtains a negative result in step 43. In this case, the controller 117 sets the main-heating time of the current inhalation to the reference time L1 (step 5).

On the other hand, if the temperature of the coil is higher than the first reference temperature, the controller 117 obtains a positive result in step 43. In this case, the controller 117 sets the main-heating time of the current inhalation to the time L2 shorter than the reference time (step 6).

After the main-heating time is set in step 5 or step 6, the controller 117 sequentially executes step 8 and step 9, and completes one cycle of inhalation.

On the other hand, if a positive result is obtained in step 1 (i.e., if the preheating mode is on), the controller 117 also determines whether the start of the preheating is detected (step 41A).

If the start of the preheating is not detected, the controller 117 obtains a negative result in step 41A. The controller 117 repeats the determination of step 41A while a negative result is obtained in step 41A.

On the other hand, if the start of the preheating is detected, the controller 117 obtains a positive result in step 41A. If a positive result is obtained in step 41A, the controller 117 starts the main heating (step 1100A) after the end of the preheating. Subsequently, the controller 117 acquires the temperature of the coil at the start of the preheating (step 42A).

When the temperature of the coil is acquired, the controller 117 determines whether the temperature of the coil at the start of the preheating is higher than the first reference temperature (step 43A). The threshold used for the determination of step 43A may be different from that for step 43. For example, the threshold used for the determination of step 43A may be smaller than the threshold used for the determination of step 43.

If the temperature of the coil is equal to or lower than the first reference temperature, the controller 117 obtains a negative result in step 43A. In this case, the controller 117 sets the main-heating time of the current inhalation to the time L2 shorter than the reference time (step 6). The main-heating time set when a negative result is obtained in step 43A is desirably shorter than the reference time L1, and need not be L2.

On the other hand, if the temperature of the coil is higher than the first reference temperature, the controller 117 obtains a positive result in step 43A. In this case, the controller 117 sets the main-heating time of the current inhalation to the time L3 (<L2) shorter than the reference time (step 7).

After the main-heating time is set in step 6 or step 7, the controller 117 sequentially executes step 8 and step 9, and completes one cycle of inhalation.

In the present embodiment, the controller 117 detects the occurrence of a short puff, which causes drying up, with a focus on the temperature of the heater 211 for generating an aerosol. Thus, the occurrence of drying up can be effectively prevented or reduced.

Also in the present embodiment, if a short puff is detected in the use of the preheating, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

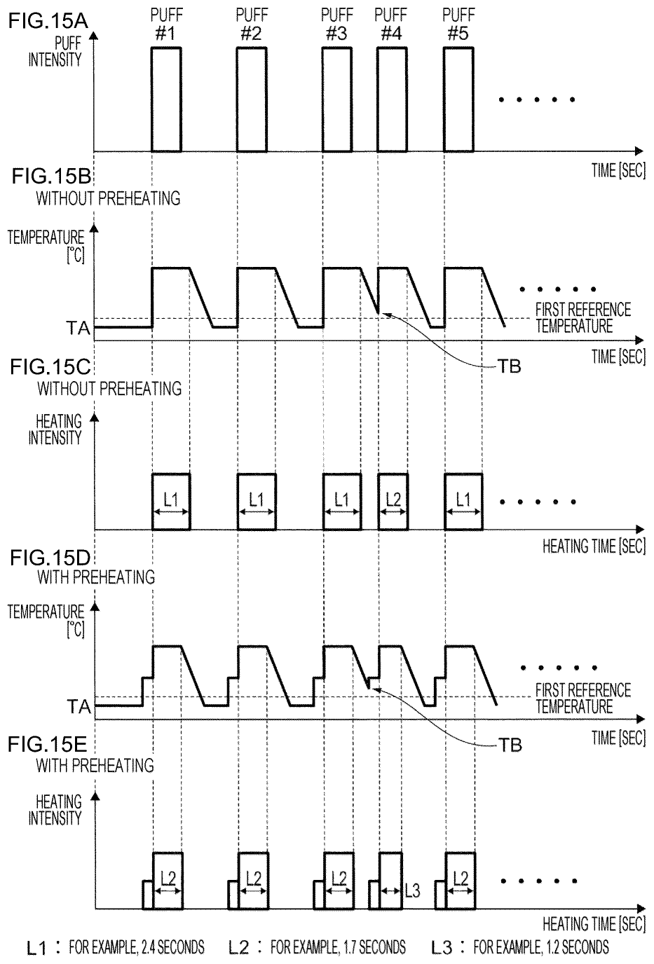

FIGS. 15A to 15E are diagrams illustrating a relationship between a puff interval and a set main-heating time in Embodiment 5. FIG. 15A illustrates example timings of inhalation (puff), FIG. 15B illustrates a temperature change of the heater 211 in the absence of preheating, FIG. 15C illustrates an example of setting of the main-heating time in the absence of preheating, FIG. 15D illustrates a temperature change of the heater 211 in the presence of preheating, and FIG. 15E illustrates an example of setting of the main-heating time in the presence of preheating. In FIG. 15A, the vertical axis represents puff intensity. In FIGS. 15B and 15D, the vertical axis represents temperature. In FIGS. 15C and 15E, the vertical axis represents heating intensity. In FIGS. 15A to 15E, the horizontal axis represents time.

Also in FIG. 15A, the number of inhalations (puffs) is five.

In FIG. 15B corresponding to the absence of preheating, temperatures TA of the heater 211 at the start of the first puff, the second puff, the third puff, and the fifth puff are lower than the first reference temperature. However, a temperature TB of the heater 211 at the start of the fourth puff is higher than the first reference temperature. This is because the puff interval is short and the cooling of the heater 211 is not in time.

Accordingly, in the example illustrated in FIG. 15C, the main-heating times LT1 of the first puff, the second puff, the third puff, and the fifth puff are set to the reference time L1, whereas the main-heating time LT1 of the fourth puff is set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff.

Also in FIG. 15D corresponding to the presence of preheating, the temperatures TA of the heater 211 at the start of the first puff, the second puff, the third puff, and the fifth puff are lower than the first reference temperature. However, the temperature TB of the heater 211 at the start of the fourth puff is higher than the first reference temperature.

Accordingly, in the example illustrated in FIG. 15E, the main-heating times LT11 of the first puff, the second puff, the third puff, and the fifth puff are set to the time L2, whereas the main-heating time of the fourth puff is set to the time L3.

As a result, even if the puff interval until the start of the fourth puff is short and the amount of supply of the aerosol source to be supplied to the heater 211 until the start of inhalation is small, the main-heating time LT11 is shorter than the reference time L1. Thus, no drying up occurs during the fourth puff.

### Embodiment 6

Embodiment 6 also describes an example of a method for indirectly detecting the occurrence of a short puff. In the present embodiment, a change in resistance value is used to detect a high-temperature state of the heater 211 at the start of inhalation.

An aerosol generation device 1 according to the present embodiment also has the same external configuration as that in Embodiment 1. However, the aerosol generation device 1 provided in the present embodiment has an internal configuration that is partially different from that in Embodiment 1.

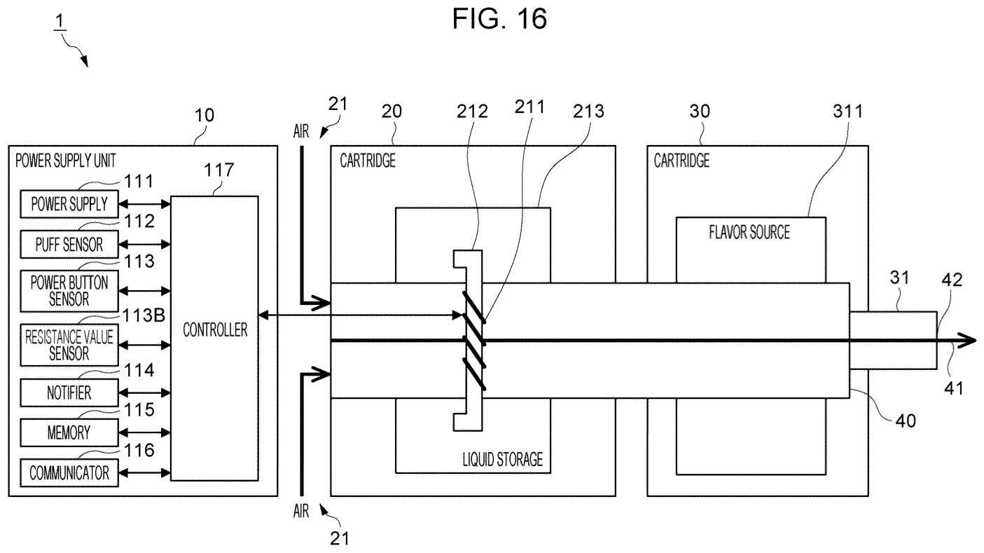

FIG. 16 is a diagram schematically illustrating an internal configuration of the aerosol generation device 1 provided in Embodiment 6. In FIG. 16, parts corresponding to those in FIG. 2 are denoted by corresponding reference numerals.

Unlike the aerosol generation device 1 illustrated in FIG. 2, the aerosol generation device 1 illustrated in FIG. 16 is provided with a resistance value sensor 113B. The measurement target of the resistance value sensor 113B is the resistance value of the heater 211.

For example, the resistance value sensor 113B measures the current value flowing through the heater 211 to detect the resistance value of the heater 211. In this method, a change in resistance value caused by a temperature change of the heater 211 is detected as a change in current value.

Further, for example, the resistance value sensor 113B measures a voltage value appearing across a resistor connected in series to the heater 211 to detect a change in the resistance value of the heater 211. In this method, a change in the resistance value of the heater 211 caused by a temperature change is detected through a change in voltage appearing across a resistor connected in series to the heater 211.

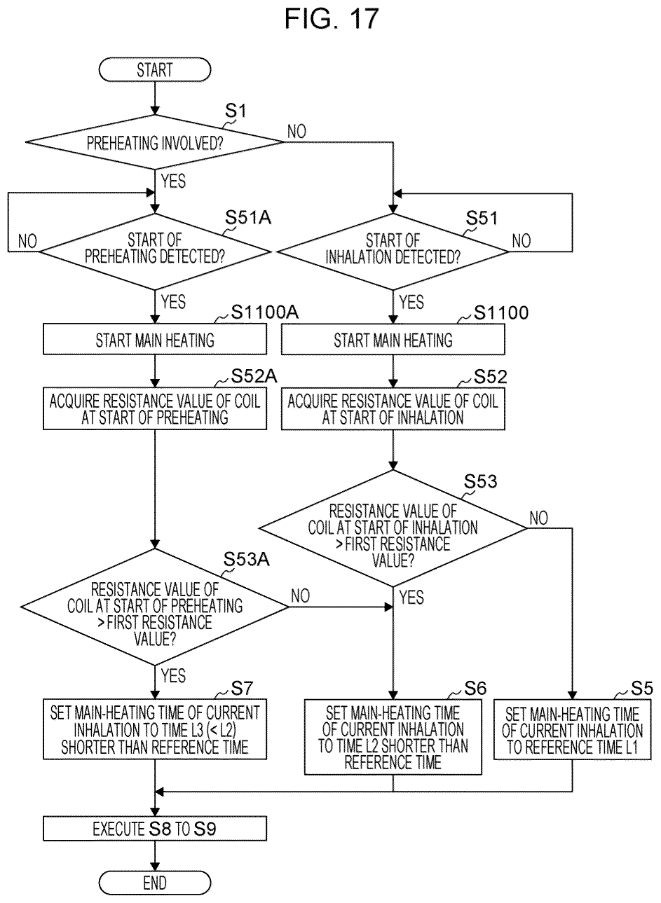

FIG. 17 is a flowchart illustrating an example of control of the main-heating time by the controller 117 (see FIG. 2) used in Embodiment 6. In FIG. 17, parts corresponding to those in FIG. 4 are denoted by corresponding reference numerals. The control by the controller 117 is implemented through execution of a program.

Also in the present embodiment, first, the controller 117 determines whether the preheating is involved (step 1). If a negative result is obtained in step 1 (i.e., if the preheating mode is off), the controller 117 determines whether the puff sensor 112 has detected the start of inhalation (step 51). This determination is performed when the main heating starts in response to the start of inhalation by the user.

As in Embodiment 2, it may be determined whether heating of the heater 211 has started. Alternatively, as in Embodiment 4, it may be determined whether a turn-on operation of the power button 11 (see FIG. 1) has been performed.

If the start of inhalation of the aerosol by the user is not detected, the controller 117 obtains a negative result in step 51. The controller 117 repeats the determination of step 51 while a negative result is obtained in step 51.

On the other hand, if the start of inhalation of the aerosol by the user is detected, the controller 117 obtains a positive result in step 51. If a positive result is obtained in step 51, the controller 117 starts the main heating (step 1100), and then acquires the resistance value of the coil at the start of inhalation (step 52). The resistance value of the coil is the resistance value of the heater 211.

When the resistance value of the coil is acquired, the controller 117 determines whether the resistance value of the coil at the start of inhalation is larger than a first resistance value (step 53). The first resistance value is determined in accordance with an actual measurement value of a change in resistance value according to the elapsed time from the end of the supply of electric power to the heater 211. The first resistance value is set to an intermediate value between a resistance value that appears for a short puff and a resistance value that appears for a non-short puff.

If the resistance value of the coil is equal to or less than the first resistance value, the controller 117 obtains a negative result in step 53. In this case, the controller 117 sets the main-heating time of the current inhalation to the reference time L1 (step 5).

On the other hand, if the resistance value of the coil is larger than the first resistance value, the controller 117 obtains a positive result in step 53. In this case, the controller 117 sets the main-heating time of the current inhalation to the time L2 shorter than the reference time (step 6).

After the main-heating time is set in step 5 or step 6, the controller 117 sequentially executes step 8 and step 9, and completes one cycle of inhalation.

On the other hand, if a positive result is obtained in step 1 (i.e., if the preheating mode is on), the controller 117 determines whether the start of the preheating is detected (step 51A).

If the start of the preheating is not detected, the controller 117 obtains a negative result in step 51A. The controller 117 repeats the determination of step 51A while a negative result is obtained in step 51A.

On the other hand, if the start of the preheating is detected, the controller 117 obtains a positive result in step 51A. If a positive result is obtained in step 51A, the controller 117 starts the main heating (step 1100A) after the end of the preheating. Subsequently, the controller 117 acquires the resistance value of the coil at the start of the preheating (step 52A).

When the resistance value of the coil is acquired, the controller 117 determines whether the resistance value of the coil at the start of the preheating is larger than the first resistance value (step 53A). The threshold used for the determination of step 53A may be different from that for step 53. For example, the threshold used for the determination of step 53A may be smaller than the threshold used for the determination of step 53.

If the resistance value of the coil is equal to or less than the first resistance value, the controller 117 obtains a negative result in step 53A. In this case, the controller 117 sets the main-heating time of the current inhalation to the time L2 shorter than the reference time (step 6). The main-heating time set when a negative result is obtained in step 53A is desirably shorter than the reference time L1, and need not be L2.

On the other hand, if the resistance value of the coil is larger than the first resistance value, the controller 117 obtains a positive result in step 53A. In this case, the controller 117 sets the main-heating time of the current inhalation to the time L3 (<L2) shorter than the reference time (step 7).

After the main-heating time is set in step 6 or step 7, the controller 117 sequentially executes step 8 and step 9, and completes one cycle of inhalation.

In the present embodiment, the controller 117 detects the occurrence of a short puff, which causes drying up, with a focus on the resistance value of the heater 211 for generating an aerosol. Thus, the occurrence of drying up can be effectively prevented or reduced.

Also in the present embodiment, if a short puff is detected during the preheating, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

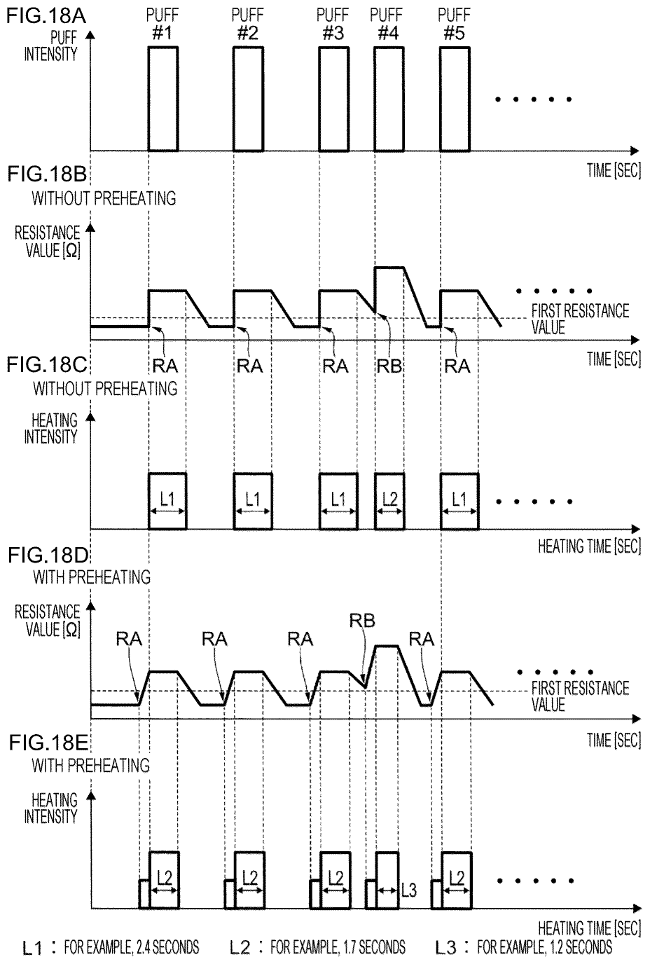

FIGS. 18A to 18E are diagrams illustrating a relationship between a puff interval and a set main-heating time in Embodiment 6. FIG. 18A illustrates example timings of inhalation (puff), FIG. 18B illustrates a change in the resistance value of the heater 211 in the absence of preheating, FIG. 18C illustrates an example of setting of the main-heating time in the absence of preheating, FIG. 18D illustrates a change in the resistance value of the heater 211 in the presence of preheating, and FIG. 18E illustrates an example of setting of the main-heating time in the presence of preheating. In FIG. 18A, the vertical axis represents puff intensity. In FIGS. 18B and 18D, the vertical axis represents resistance value. In FIGS. 18C and 18E, the vertical axis represents heating intensity. In FIGS. 18A to 18E, the horizontal axis represents time.

Also in FIG. 18A, the number of inhalations (puffs) is five. In FIG. 18A, it is assumed that the interval between the first puff and the second puff and the interval between the second puff and the third puff are relatively long, and the interval between the third puff and the fourth puff and the interval between the fourth puff and the fifth puff are relatively short.

Accordingly, in the example illustrated in FIG. 18B, resistance values RA of the coil at the start of the second puff, the start of the third puff, and the start of the fifth puff are lower than the first resistance value. This is because the temperature of the coil decreases and the resistance value also decreases as a result of the elapse of time from the end of the immediately preceding heating.

However, a resistance value RB of the coil at the start of the fourth puff is higher than the first resistance value. This is because the interval between the third and fourth puff is short and the temperature of the heater 211 is not sufficiently lowered.

Accordingly, in the example illustrated in FIG. 18C, the main-heating times LT1 of the first, second, third, and fifth puffs are set to the reference time L1, whereas the main-heating time LT1 of the fourth puff is set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff.

By contrast, in the example illustrated in FIG. 18D corresponding to the presence of preheating, the resistance values RA of the coil at the start of the first preheating, the start of the second preheating, the start of the third preheating, and the start of the fifth preheating are lower than the first resistance value. This is because the temperature of the coil decreases and the resistance value also decreases as a result of the elapse of time from the end of the immediately preceding heating.

However, the resistance value RB of the coil at the start of the fourth preheating is higher than the first resistance value. This is because the interval between the third and fourth puff is short and the temperature of the heater 211 is not sufficiently lowered.

Accordingly, in the example illustrated in FIG. 18E, the main-heating times LT11 of the first, second, third, and fifth puffs are set to the time L2, whereas the main-heating time LT11 of the fourth puff is set to the time L3.

As a result, even if the puff interval until the start of the fourth puff is short and the amount of supply of the aerosol source to be supplied to the heater 211 until the start of inhalation is small, the main-heating time LT11 is shorter than the reference time L1. Thus, no drying up occurs during the fourth puff.

### Embodiment 7

Embodiment 7 also describes an example of a method for indirectly detecting the occurrence of a short puff. In the present embodiment, the temperature change of the liquid guide 212 is used to detect a high-temperature state of the heater 211 at the start of inhalation.

An aerosol generation device 1 according to the present embodiment also has the same external configuration as that in Embodiment 1. However, the aerosol generation device 1 provided in the present embodiment has an internal configuration that is partially different from that in Embodiment 1.

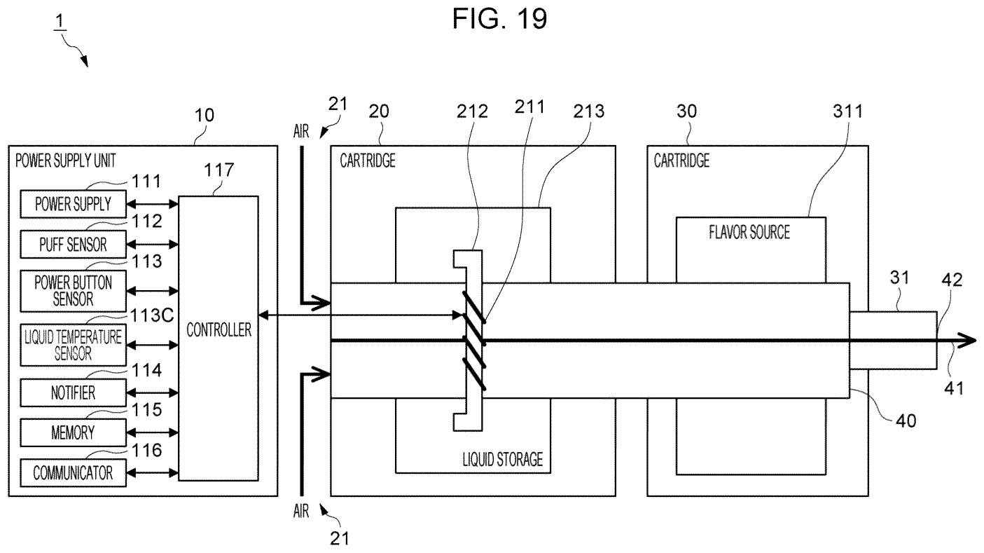

FIG. 19 is a diagram schematically illustrating an internal configuration of the aerosol generation device 1 provided in Embodiment 7. In FIG. 19, parts corresponding to those in FIG. 2 are denoted by corresponding reference numerals.

Unlike the aerosol generation device 1 illustrated in FIG. 2, the aerosol generation device 1 illustrated in FIG. 19 is provided with a liquid temperature sensor 113C. The measurement target of the liquid temperature sensor 113C is the temperature of the liquid guide 212. For this reason, the liquid temperature sensor 113C is disposed in the vicinity of the liquid guide 212. For example, a temperature sensor or a thermistor is used as the liquid temperature sensor 113C. The liquid temperature sensor 113C is an example of a third sensor.

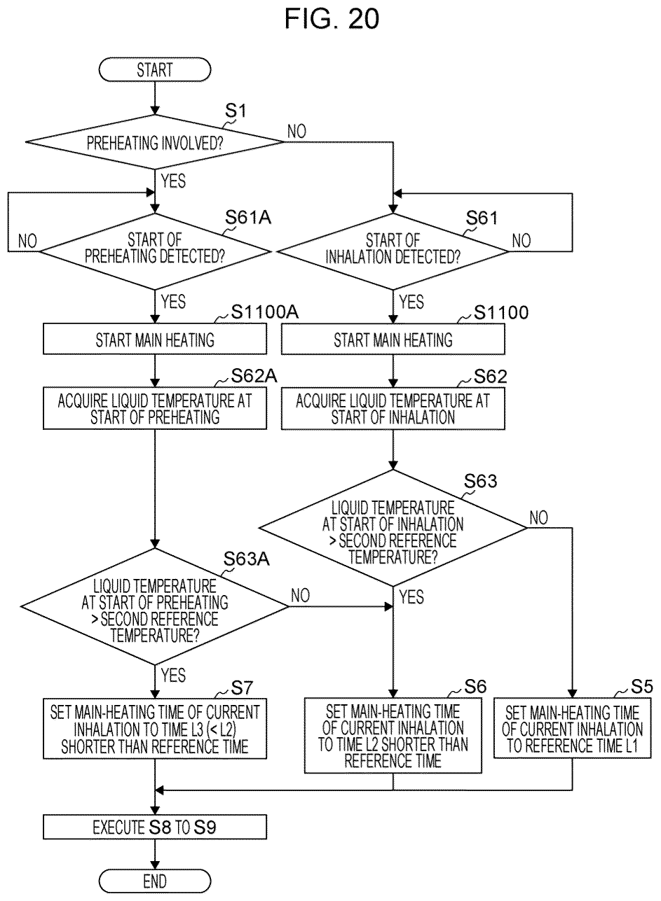

FIG. 20 is a flowchart illustrating an example of control of the main-heating time by the controller 117 (see FIG. 2) used in Embodiment 7. In FIG. 20, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 61).

If the start of inhalation of the aerosol by the user is not detected, the controller 117 obtains a negative result in step 61. The controller 117 repeats the determination of step 61 while a negative result is obtained in step 61.

On the other hand, if the start of inhalation of the aerosol by the user is detected, the controller 117 obtains a positive result in step 61. If a positive result is obtained in step 61, the controller 117 starts the main heating (step 1100), and then acquires the liquid temperature at the start of inhalation (step 62). The liquid temperature is the temperature of the liquid guide 212.

When the temperature of the liquid guide 212 is acquired, the controller 117 determines whether the liquid temperature at the start of inhalation is higher than a second reference temperature (step 63). The second reference temperature is determined in accordance with an actual measurement value of a change in the liquid temperature according to the elapsed time from the end of the supply of electric power to the heater 211.

If the liquid temperature is equal to or lower than the second reference temperature, the controller 117 obtains a negative result in step 63. In this case, the controller 117 sets the main-heating time of the current inhalation to the reference time L1 (step 5).

On the other hand, if the liquid temperature is higher than the second reference temperature, the controller 117 obtains a positive result in step 63. In this case, the controller 117 sets the main-heating time of the current inhalation to the time L2 shorter than the reference time (step 6).

After the main-heating time is set in step 5 or step 6, the controller 117 sequentially executes step 8 and step 9, and completes one cycle of inhalation.

On the other hand, if a positive result is obtained in step 1 (i.e., if the preheating mode is on), the controller 117 determines whether the start of the preheating is detected (step 61A).

If the start of the preheating is not detected, the controller 117 obtains a negative result in step 61A. The controller 117 repeats the determination of step 61A while a negative result is obtained in step 61A.

On the other hand, if the start of the preheating is detected, the controller 117 obtains a positive result in step 61A. If a positive result is obtained in step 61A, the controller 117 starts the main heating (step 1100A) after the end of the preheating. Subsequently, the controller 117 acquires the liquid temperature at the start of the preheating (step 62A). The liquid temperature is the temperature of the liquid guide 212.

When the temperature of the liquid guide 212 is acquired, the controller 117 determines whether the liquid temperature at the start of the preheating is higher than the second reference temperature (step 63A). The threshold used for the determination of step 63A may be different from that for step 63. For example, the threshold used for the determination of step 63A may be smaller than the threshold used for the determination of step 63.

If the liquid temperature is equal to or lower than the second reference temperature, the controller 117 obtains a negative result in step 63A. In this case, the controller 117 sets the main-heating time of the current inhalation to the time L2 shorter than the reference time (step 6). The main-heating time set when a negative result is obtained in step 63A is desirably shorter than the reference time L1, and need not be L2.

On the other hand, if the liquid temperature is higher than the second reference temperature, the controller 117 obtains a positive result in step 63A. In this case, the controller 117 sets the main-heating time of the current inhalation to the time L3 (<L2 shorter than the reference time (step 7).

After the main-heating time is set in step 6 or step 7, the controller 117 sequentially executes step 8 and step 9, and completes one cycle of inhalation.

In the present embodiment, the controller 117 detects the occurrence of a short puff, which causes drying up, with a focus on the liquid temperature of the heater 211 for generating an aerosol. Thus, the occurrence of drying up can be effectively prevented or reduced.

Also in the present embodiment, if a short puff is detected in the use of the preheating, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

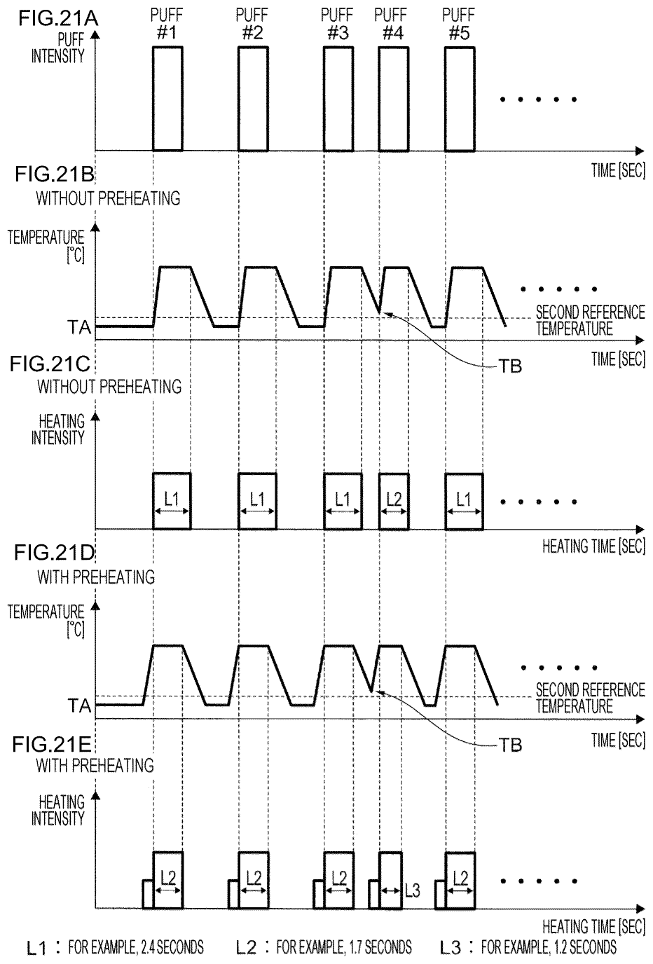

FIGS. 21A to 21E are diagrams illustrating a relationship between a puff interval and a set main-heating time in Embodiment 7. FIG. 21A illustrates example timings of inhalation (puff), FIG. 21B illustrates a change in the temperature of the liquid guide 212 in the absence of preheating, FIG. 21C illustrates an example of setting of the main-heating time in the absence of preheating, FIG. 21D illustrates a change in the temperature of the liquid guide 212 in the presence of preheating, and FIG. 21E illustrates an example of setting of the main-heating time in the presence of preheating. In FIG. 21A, the vertical axis represents puff intensity. In FIGS. 21B and 21D, the vertical axis represents temperature. In FIGS. 21C and 21E, the vertical axis represents heating intensity. In FIGS. 21A to 21E, the horizontal axis represents time.

Also in FIG. 21A, the number of inhalations (puffs) is five. Also in FIG. 21A, it is assumed that the interval between the first puff and the second puff and the interval between the second puff and the third puff are relatively long, and the interval between the third puff and the fourth puff and the interval between the fourth puff and the fifth puff are relatively short.

Accordingly, in the example illustrated in FIG. 21B corresponding to the absence of preheating, liquid temperatures TA at the start of the first puff, the start of the second puff, the start of the third puff, and the start of the fifth puff are lower than the second reference temperature. This is because, as a result of the elapse of time from the end of the immediately preceding heating, heating is started from a state in which the liquid temperature has dropped to room temperature or close to room temperature.

However, a liquid temperature TB at the start of the fourth puff is higher than the second reference temperature. This is because the interval between the third puff and the fourth puff is short and the temperature of the liquid guide 212 is not sufficiently lowered.

Accordingly, in the example illustrated in FIG. 21C, the main-heating times LT1 of the first puff, the second puff, the third puff, and the fifth puff are set to the reference time L1, whereas the main-heating time LT1 of the fourth puff is set to the time L2 shorter than the reference time L1.

As a result, even if the puff interval until the start of the fourth puff is short and the amount of supply of the aerosol source to be supplied to the heater 211 until the start of inhalation is small, the main-heating time LT1 is shorter than the reference time L1. Thus, no drying up occurs during the fourth puff.

In the example illustrated in FIG. 21D corresponding to the presence of preheating, the liquid temperatures TA at the start of the first puff, the start of the second puff, the start of the third puff, and the start of the fifth puff are lower than the second reference temperature. This is because, as a result of the elapse of time from the end of the immediately preceding heating, heating is started from a state in which the liquid temperature has dropped to room temperature or close to room temperature.

However, the liquid temperature TB at the start of the fourth puff is higher than the second reference temperature. This is because the interval between the third puff and the fourth puff is short and the temperature of the liquid guide 212 is not sufficiently lowered.

Accordingly, in the example illustrated in FIG. 21E, the main-heating times LT11 of the first puff, the second puff, the third puff, and the fifth puff are set to the time L2, whereas the main-heating time LT11 of the fourth puff is set to the time L3.

As a result, even if the puff interval until the start of the fourth puff is short and the amount of supply of the aerosol source to be supplied to the heater 211 until the start of inhalation is small, the main-heating time LT11 is shorter than the reference time L1. Thus, no drying up occurs during the fourth puff.

Since the main-heating time LT11 corresponding to the fourth puff is shortened, even if the interval between the fourth puff and the fifth puff is short, the heating stop time of the heater 211 is long. Thus, the liquid temperature can be made lower than the second reference temperature before the start of the fifth puff. Accordingly, the main-heating time LT11 corresponding to the fifth puff returns to the time L2 again.

### Embodiment 8

The present embodiment provides a case where the air temperature in an environment in which the aerosol generation device 1 is used is low. In high-latitude countries or regions, the outside air temperature in winter is low. When the outside air temperature is low, the liquid temperature of the aerosol source stored in the liquid storage 213 of the aerosol generation device 1 is also low, and the viscosity increases simultaneously. As the viscosity increases, the liquid feed rate of the aerosol decreases, as compared with when the air temperature is high in a case where the puff interval is short, as well as in a case where the puff interval is long. As a result, if the amount of supply of the aerosol source to be supplied to the heater 211 until the start of inhalation falls below the amount of liquid required for the generation of aerosol, the same phenomenon as drying up occurs.

In the present embodiment, accordingly, a focus is on the air temperature in an environment or atmosphere in which the aerosol generation device 1 is used.

An aerosol generation device 1 according to the present embodiment also has the same external configuration as that in Embodiment 1. However, the aerosol generation device 1 provided in the present embodiment has an internal configuration that is partially different from that in Embodiment 1.

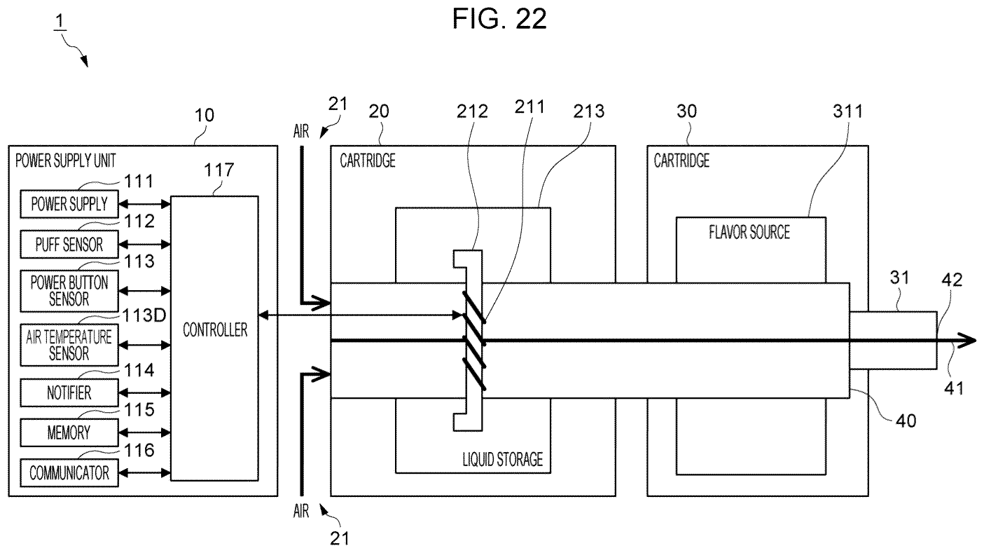

FIG. 22 is a diagram schematically illustrating an internal configuration of the aerosol generation device 1 provided in Embodiment 8. In FIG. 22, parts corresponding to those in FIG. 2 are denoted by corresponding reference numerals.

Unlike the aerosol generation device 1 illustrated in FIG. 2, the aerosol generation device 1 illustrated in FIG. 22 is provided with an air temperature sensor 113D. The measurement target of the air temperature sensor 113D is the ambient air temperature. For this reason, the air temperature sensor 113D is desirably disposed as far as possible from the heat source in the device. However, since the viscosity of the aerosol source depends on the liquid temperature of the aerosol source stored in the liquid storage 213, the liquid temperature sensor may be disposed in the vicinity of the liquid storage 213.

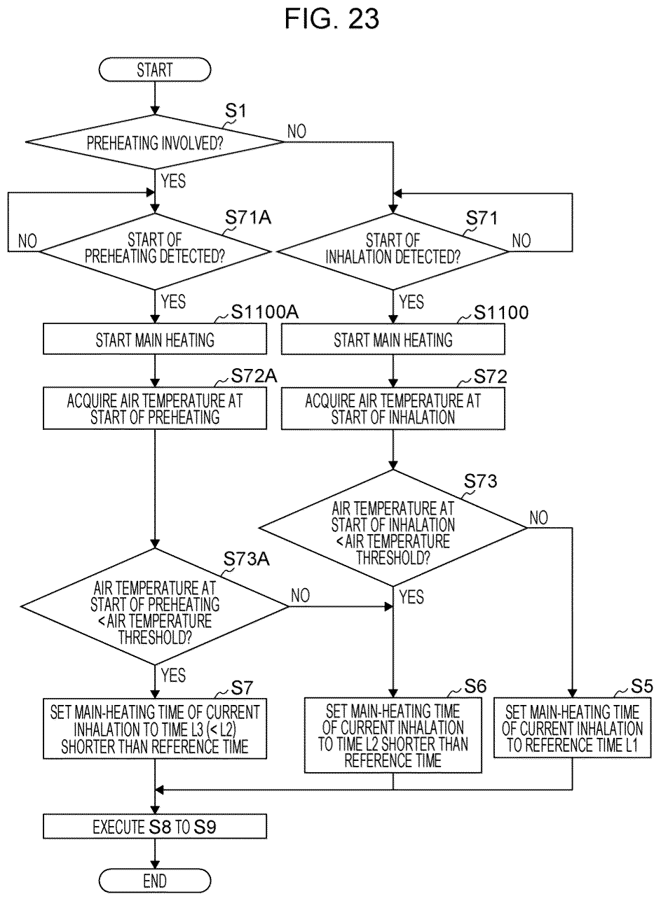

FIG. 23 is a flowchart illustrating an example of control of the main-heating time by the controller 117 (see FIG. 2) used in Embodiment 8. In FIG. 23, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 71). This determination is performed when the main heating starts in response to the start of inhalation by the user.

If the start of inhalation of the aerosol by the user is not detected, the controller 117 obtains a negative result in step 71. The controller 117 repeats the determination of step 71 while a negative result is obtained in step 71.

On the other hand, if the start of inhalation of the aerosol by the user is detected, the controller 117 obtains a positive result in step 71. If a positive result is obtained in step 71, the controller 117 starts the main heating (step 1100), and then acquires the air temperature at the start of inhalation (step 72). The air temperature is the ambient air temperature around the aerosol generation device 1.

When the ambient air temperature is acquired, the controller 117 determines whether the air temperature at the start of inhalation is lower than a threshold for air temperature determination (hereinafter referred to as an “air temperature threshold”) (step 73). The air temperature threshold is determined in accordance with the relationship between the viscosity of the aerosol source and the air temperature.

If the air temperature is equal to or higher than the air temperature threshold, the controller 117 obtains a negative result in step 73. In this case, the controller 117 sets the main-heating time of the current inhalation to the reference time L1 (step 5).

On the other hand, if the air temperature is lower than the air temperature threshold, the controller 117 obtains a positive result in step 73. In this case, the controller 117 sets the main-heating time of the current inhalation to the time L2 shorter than the reference time (step 6).

After the main-heating time LT1 is set in step 5 or step 6, the controller 117 sequentially executes step 8 and step 9, and completes one cycle of inhalation.

If a positive result is obtained in step 1 (i.e., if the preheating mode is on), the controller 117 determines whether the start of the preheating is detected (step 71A).

If the start of the preheating is not detected, the controller 117 obtains a negative result in step 71A. The controller 117 repeats the determination of step 71A while a negative result is obtained in step 71A.

On the other hand, if the start of the preheating is detected, the controller 117 obtains a positive result in step 71A. If a positive result is obtained in step 71A, the controller 117 starts the main heating (step 1100A) after the end of the preheating. Subsequently, the controller 117 acquires the air temperature at the start of the preheating (step 72A).

When the ambient air temperature is acquired, the controller 117 determines whether the air temperature at the start of the preheating is lower than the air temperature threshold for air temperature determination (step 73A). The threshold used for the determination of step 73A may be different from that for step 73. For example, the threshold used for the determination of step 73A may be smaller than the threshold used for the determination of step 73.

If the air temperature is equal to or higher than the air temperature threshold, the controller 117 obtains a negative result in step 73A. In this case, the controller 117 sets the main-heating time of the current inhalation to the time L2 shorter than the reference time (step 6). The main-heating time set when a negative result is obtained in step 73A is desirably shorter than the reference time L1, and need not be L2.

On the other hand, if the air temperature is lower than the air temperature threshold, the controller 117 obtains a positive result in step 73A. In this case, the controller 117 sets the main-heating time of the current inhalation to the time L3 (<L2) shorter than the reference time (step 7).

After the main-heating time LT11 is set in step 6 or step 7, the controller 117 sequentially executes step 8 and step 9, and completes one cycle of inhalation.

In the present embodiment, the controller 117 detects use in an environment in which drying up occurs, with a focus on the ambient air temperature at which the efficiency of aerosol generation decreases. Thus, the occurrence of drying up can be effectively prevented or reduced.

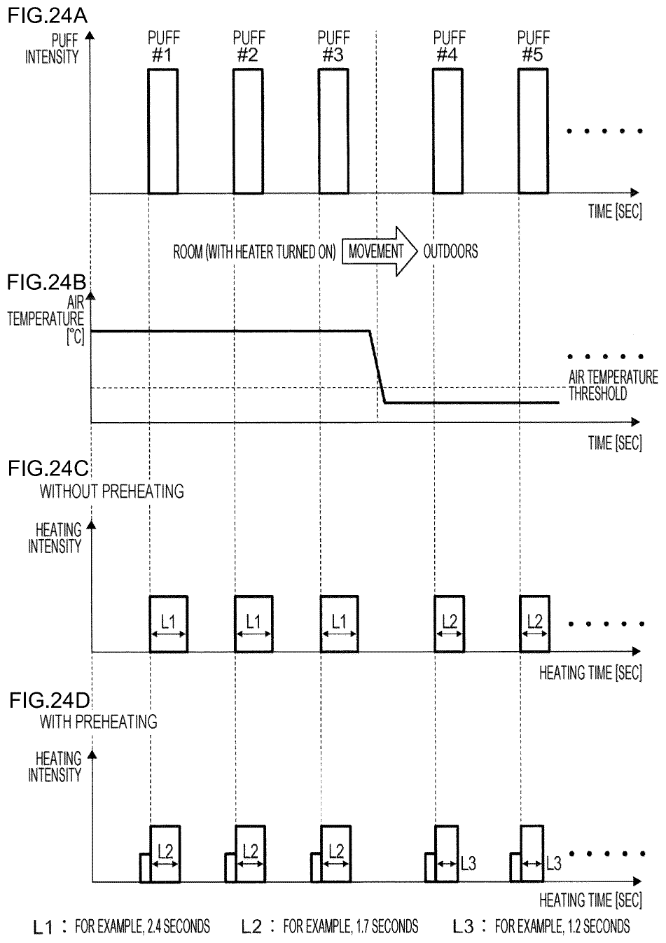

FIGS. 24A to 24D are diagrams illustrating a relationship between a puff interval and a set main-heating time in Embodiment 8. FIG. 24A illustrates example timings of inhalation (puff), FIG. 24B illustrates a change in ambient air temperature, FIG. 24C illustrates an example of setting of the main-heating time without the preheating, and FIG. 24D illustrates an example of setting of the main-heating time with the preheating. In FIG. 24A, the vertical axis represents puff intensity. In FIG. 24B, the vertical axis represents air temperature. In FIGS. 24C and 24D, the vertical axis represents heating intensity. In FIGS. 24A to 24D, the horizontal axis represents time.

FIG. 24B illustrates a change in ambient air temperature at which the aerosol generation device 1 is used. In FIG. 24B, it is assumed that as a result of movement from a room with a heater turned on to the outdoors in winter, the air temperature drops to such an extent that the viscosity of the aerosol source is affected.

Also in FIG. 24A, the number of inhalations (puffs) is five. In FIG. 24A, none of the interval between the first puff and the second puff, the interval between the second puff and the third puff, the interval between the third puff and the fourth puff, and the interval between the fourth puff and the fifth puff is a short puff.

Note that the first puff, the second puff, and the third puff are performed indoors, whereas the fourth puff and the fifth puff are performed outdoors. Accordingly, in FIG. 24B, the air temperature drops between the third puff and the fourth puff.

It is assumed that a period of time during which the liquid temperature of the aerosol source decreases is present between the third puff and the fourth puff, and consequently, the liquid temperature of the aerosol source is close to the air temperature at the start of the fourth puff. It is also assumed that the liquid temperature of the aerosol source at that time is lowered to a value lower than the air temperature threshold.

Accordingly, in the example illustrated in FIG. 24C, the main-heating times LT1 of the first puff, the second puff, and the third puff are set to the reference time L1, whereas the main-heating times LT1 of the fourth puff and the fifth puff are set to the time L2 shorter than the reference time L1.

Likewise, in the example illustrated in FIG. 24D, the main-heating times LT11 of the first puff, the second puff, and the third puff are set to the time L2, whereas the main-heating times LT11 of the fourth puff and the fifth puff are set to the time L3.

As a result, even if the amount of supply of the aerosol source to be supplied to the heater 211 until the start of inhalation is small in the fourth puff and the fifth puff due to the low ambient air temperature, the main-heating time LT11 is shorter than the reference time L1. Thus, no drying up occurs.

### Embodiment 9

The present embodiment describes a case where the main-heating time is controlled by predicting the occurrence of drying up. The other configurations of the aerosol generation device 1 (see FIG. 1) in the present embodiment are the same as those in Embodiment 1. That is, the aerosol generation device 1 has the same external configuration and internal configuration as those in Embodiment 1.

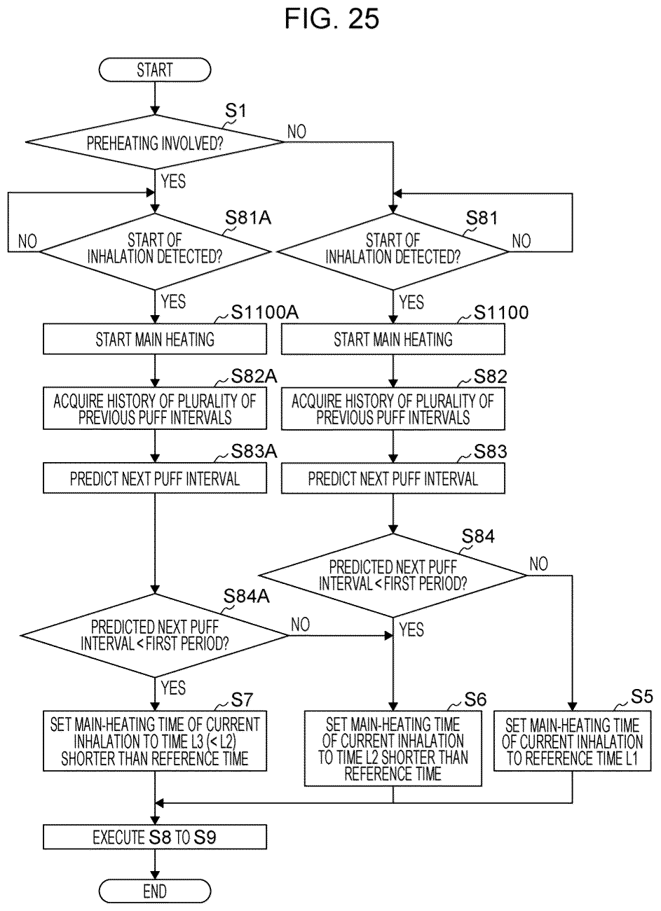

FIG. 25 is a flowchart illustrating an example of control of the main-heating time by the controller 117 (see FIG. 2) used in Embodiment 9. In FIG. 25, parts corresponding to those in FIG. 4 are denoted by corresponding reference numerals. The control by the controller 117 is implemented through execution of a program.

In the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 81).

If the start of inhalation of the aerosol by the user is not detected, the controller 117 obtains a negative result in step 81. The controller 117 repeats the determination of step 81 while a negative result is obtained in step 81.

On the other hand, if the start of inhalation of the aerosol by the user is detected, the controller 117 obtains a positive result in step 81. If a positive result is obtained in step 81, the controller 117 starts the main heating (step 1100), and then acquires a history of a plurality of previous puff intervals (step 82). The number of puff intervals to be acquired in the history is set in advance. For example, a history of three to five puff intervals is acquired.

The purpose is to prevent drying up in the next inhalation. Thus, too many puff intervals to be acquired may hinder the knowledge of the most recent inhalation tendency. However, many puff intervals to be acquired in the history make it possible to analyze a long-term inhalation tendency of the user.

When the history of a plurality of previous puff intervals is acquired, the controller 117 predicts the next puff interval (step 83). In the embodiments described above, the latest puff interval is acquired each time a new inhalation starts. In the present embodiment, the puff interval is predicted before the next inhalation starts.

Then, the controller 117 determines whether the predicted next puff interval is shorter than the first period (step 84).

If the predicted next puff interval is equal to or longer than the first period, the controller 117 obtains a negative result in step 84. In this case, the controller 117 sets the main-heating time of the current inhalation to the reference time L1 (step 5).

On the other hand, if the predicted next puff interval is shorter than the first period, the controller 117 obtains a positive result in step 84. In this case, the controller 117 sets the main-heating time of the current inhalation to the time L2 shorter than the reference time (step 6).

After the main-heating time LT1 is set in step 5 or step 6, the controller 117 sequentially executes step 8 and step 9, and completes one cycle of inhalation.

On the other hand, if a positive result is obtained in step 1 (i.e., if the preheating mode is on), the controller 117 determines whether the puff sensor 112 has detected the start of inhalation (step 81A).

If the start of inhalation of the aerosol by the user is not detected, the controller 117 obtains a negative result in step 81A. The controller 117 repeats the determination of step 81A while a negative result is obtained in step 81A.

On the other hand, if the start of inhalation of the aerosol by the user is detected, the controller 117 obtains a positive result in step 81A. If a positive result is obtained in step 81A, the controller 117 starts the main heating (step 1100A) after the end of the preheating. Subsequently, the controller 117 acquires a history of a plurality of previous puff intervals (step 82A).

When the history of a plurality of previous puff intervals is acquired, the controller 117 predicts the next puff interval (step 83A).

Then, the controller 117 determines whether the predicted next puff interval is shorter than the first period (step 84A). The threshold used for the determination of step 84A may be different from that for step 84. For example, the threshold used for the determination of step 84A may be smaller than the threshold used for the determination of step 84.

If the predicted next puff interval is equal to or longer than the first period, the controller 117 obtains a negative result in step 84A. In this case, the controller 117 sets the main-heating time of the current inhalation to the time L2 shorter than the reference time L1 (step 6).

The main-heating time set when a negative result is obtained in step 84A is desirably shorter than the reference time L1, and need not be L2.

On the other hand, if the predicted next puff interval is shorter than the first period, the controller 117 obtains a positive result in step 84A. In this case, the controller 117 sets the main-heating time of the current inhalation to the time L3 (<L2) shorter than the reference time (step 7).

After the main-heating time LT11 is set in step 6 or step 7, the controller 117 sequentially executes step 8 and step 9, and completes one cycle of inhalation.

In the present embodiment, when the predicted value satisfies the condition for a short puff, the controller 117 shortens the main-heating time in a preventive manner. As a result, when the puff interval immediately before the start of the next inhalation is a short puff, the main-heating time of the next inhalation is the same as that in the other embodiments described above.

On the other hand, when the puff interval immediately before the start of the next inhalation is not a short puff, the main-heating time is shorter than that in the other embodiments described above. The puff interval until the next inhalation is further substantially longer accordingly, and drying up is less likely to occur.

Also in the present embodiment, if the predicted value is a short puff, the main-heating time LT11 is shorter than the reference time L1. Thus, the amount of electric power to be supplied to the heater 211 during one cycle of inhalation is smaller than the amount of electric power (reference value) to be supplied in the case of the reference time L1.

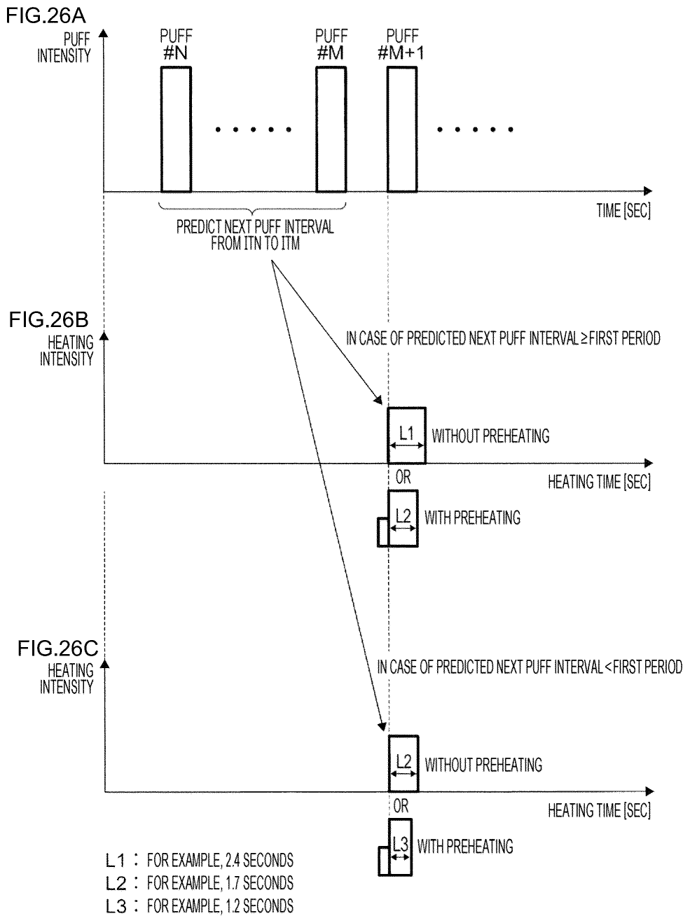

FIGS. 26A to 26C are diagrams illustrating a relationship between a puff interval and a set main-heating time in Embodiment 9. FIG. 26A illustrates example timings of inhalation (puff), FIG. 26B illustrates an example of setting of the main-heating time when a predicted puff interval is equal to or longer than the first period, and FIG. 26C illustrates an example of setting of the main-heating time when the predicted puff interval is shorter than the first period. In FIG. 26A, the vertical axis represents puff intensity. In FIGS. 26B and 26C, the vertical axis represents heating intensity. In FIGS. 26A to 26C, the horizontal axis represents time.

In FIG. 26A, before the start of the (M+1)-th puff, the next puff interval is predicted from the N puff intervals.

In the example illustrated in FIG. 26B, the predicted puff interval is not a short puff. Thus, the main-heating time LT1 without the preheating is set to the reference time L1, and the main-heating time LT11 with the preheating is set to the time L2.

In the example illustrated in FIG. 26C, the predicted puff interval is a short puff. Thus, the main-heating time LT1 without the preheating is set to the time L2, and the main-heating time LT11 with the preheating is set to the time L3.

### Embodiment 10

Also in the present embodiment, the main-heating time is set using a plurality of previous puff intervals. In the present embodiment, however, instead of prediction, the main-heating time of the current inhalation, which is in progress, is set after the start of the current inhalation, as in Embodiments 1 to 7.

The other configurations of the aerosol generation device 1 (see FIG. 1) in the present embodiment are the same as those in Embodiment 1. That is, the aerosol generation device 1 has the same external configuration and internal configuration as those in Embodiment 1.

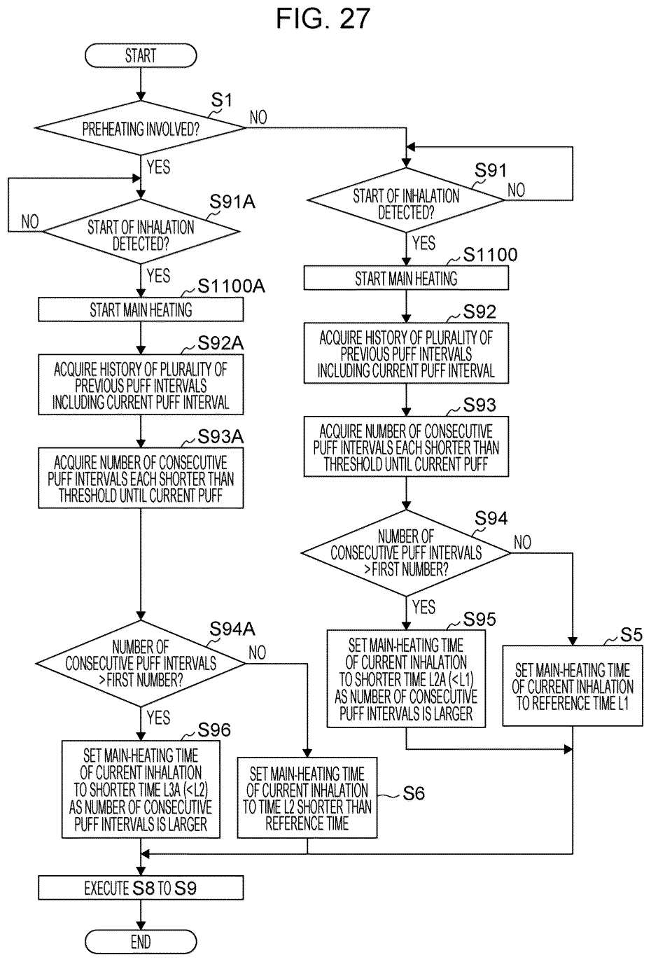

FIG. 27 is a flowchart illustrating an example of control of the main-heating time by the controller 117 (see FIG. 2) used in Embodiment 10. In FIG. 27, parts corresponding to those in FIG. 4 are denoted by corresponding reference numerals. The control by the controller 117 is implemented through execution of a program.

In the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 91). The determination of step 91 is repeated while a negative result is obtained in step 91.

If a positive result is obtained in step 91, the controller 117 starts the main heating (step 1100), and then acquires a history of a plurality of previous puff intervals including the current puff interval (step 92). In the present embodiment, since an actual measurement value is used instead of a predicted value, the current puff interval is also measured.

The number of puff intervals to be acquired in the history is set in advance. For example, a history of three to five puff intervals is acquired. The number of puff intervals to be acquired in the history is set as long as the most recent inhalation tendency is detectable.

When the history of a plurality of previous puff intervals is acquired, the controller 117 acquires the number of consecutive puff intervals each shorter than the threshold until the current puff (step 93). As the number of consecutive puff intervals increases, the likelihood that the liquid temperature of the aerosol source at the start of inhalation is high increases, and the likelihood that the supply of the aerosol source is not in time during the main heating also increases.

Instead of the number of consecutive puff intervals until the current puff, the maximum value of the number of consecutive puff intervals in the acquired history may be determined. The likelihood that the liquid temperature is high may be known without the use of the number of consecutive puff intervals until the current puff.

Then, the controller 117 determines whether the number of consecutive puff intervals is larger than a first number (step 94).

If the number of consecutive puff intervals is equal to or less than the first number, the controller 117 obtains a negative result in step 94. In this case, the controller 117 sets the main-heating time of the current inhalation to the reference time L1 (step 5). The reference time L1 is a fixed value.

On the other hand, if the number of consecutive puff intervals is larger than the first number, the controller 117 obtains a positive result in step 94. In this case, the controller 117 sets the main-heating time of the current inhalation to a shorter time L2A (<L1) as the number of consecutive puff intervals is larger (step 95). The time L2A is a variable value shorter than the reference time L1.

In the present embodiment, the controller 117 sets the time L2A to a value that decreases stepwise as the number of consecutive puff intervals increases. For example, the main-heating time LT1 is shortened by an amount given by 0.2 seconds×the number of consecutive puff intervals. In this example, the time L2A is linearly shortened in accordance with the number of consecutive puff intervals. However, the time L2A may be nonlinearly shortened in accordance with a quadratic curve or the like.

After the main-heating time LT1 is set in step 5 or step 95, the controller 117 sequentially executes step 8 and step 9, and completes one cycle of inhalation.

On the other hand, if a positive result is obtained in step 1 (i.e., if the preheating mode is on), the controller 117 determines whether the puff sensor 112 has detected the start of inhalation (step 91A). The determination of step 91A is repeated while a negative result is obtained in step 91A.

If a positive result is obtained in step 91A, the controller 117 starts the main heating (step 1100A) after the end of the preheating. Subsequently, the controller 117 acquires a history of a plurality of previous puff intervals including the current puff interval (step 92A).

When the history of a plurality of previous puff intervals is acquired, the controller 117 acquires the number of consecutive puff intervals each shorter than the threshold until the current puff (step 93A).

Then, the controller 117 determines whether the number of consecutive puff intervals is larger than the first number (step 94A). The threshold used for the determination of step 94A may be different from that for step 94. For example, the threshold used for the determination of step 94A may be smaller than the threshold used for the determination of step 94.

If the number of consecutive puff intervals is equal to or less than the first number, the controller 117 obtains a negative result in step 94A. In this case, the controller 117 sets the main-heating time of the current inhalation to the time L2 shorter than the reference time (step 6). The time L2 is a fixed value. The main-heating time set when a negative result is obtained in step 94A is desirably shorter than the reference time L1, and need not be L2.

On the other hand, if the number of consecutive puff intervals is larger than the first number, the controller 117 obtains a positive result in step 94A. In this case, the controller 117 sets the main-heating time of the current inhalation to a shorter time L3A as the number of consecutive puff intervals is larger (step 96). The time L3A, as used here, is a variable value shorter than the time L2.

After the main-heating time is set in step 6 or step 96, the controller 117 sequentially executes step 8 and step 9, and completes one cycle of inhalation.

In the present embodiment, the controller 117 shortens the main-heating time as the number of times a short puff consecutively occurs increases. This is because, as the number of consecutive short puffs increases, the main heating with the liquid temperature of the aerosol source kept high is continuously performed, resulting in it being more likely that an increase in the amount of generated aerosol causes drying up.

In the present embodiment, however, the length of the main-heating time decreases as the number of consecutive short puffs increases. Thus, drying up is effectively prevented or reduced.

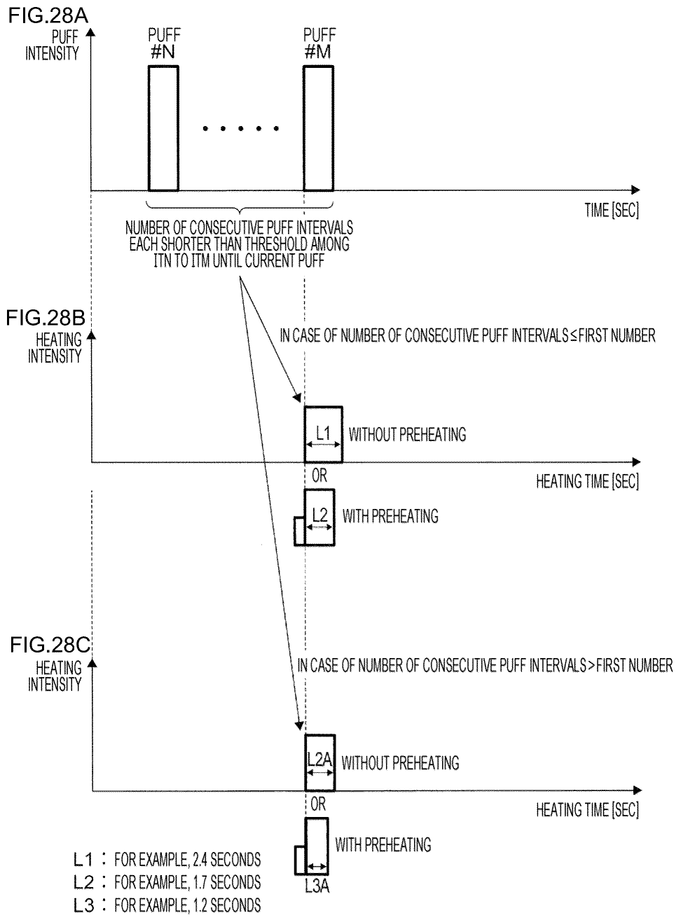

FIGS. 28A to 28C are diagrams illustrating a relationship between a puff interval and a set main-heating time in Embodiment 10. FIG. 28A illustrates example timings of inhalation (puff), FIG. 28B illustrates an example of setting of the main-heating time when the number of consecutive short puffs is equal to or less than the first number, and FIG. 28C illustrates an example of setting of the main-heating time when the number of consecutive short puffs is greater than the first number.

In FIG. 28A, the vertical axis represents puff intensity. In FIGS. 28B and 28C, the vertical axis represents heating intensity. In FIGS. 28A to 28C, the horizontal axis represents time.

In FIG. 28A, the number of consecutive short puffs up to the current puff among N puff intervals up to the M-th puff is acquired.

In the example illustrated in FIG. 28B, the number of consecutive puff intervals is equal to or less than the first number. Thus, the main-heating time LT1 without the preheating is set to the reference time L1, and the main-heating time LT11 with the preheating is set to the time L2.

In the example illustrated in FIG. 28C, the number of consecutive puff intervals is larger than the first number. Thus, the main-heating time LT1 without the preheating is set to the time L2A shorter than the reference time, and the main-heating time LT11 with the preheating is set to the time L3A shorter than the time L2.

### Embodiment 11

The present embodiment describes a modification of Embodiment 10. In Embodiment 10, the number of consecutive short puffs is counted, and the count is reset when the puff interval exceeds the threshold even slightly.

However, in some cases, it is desirable to substantially identify a short puff for an inhalation exceeding the threshold, in terms of prevention or reduction in drying up. For example, this case applies to a user whose puff interval is slightly greater than the threshold or a user whose puff interval varies slightly across the threshold.

In the case of these users, even if the number acquired in step 93 (see FIG. 27) is small, the liquid temperature at the start of the main heating is likely to be high as in the case of a large number of consecutive short puffs.

The present embodiment describes measures against this kind of phenomenon.

The other configurations of the aerosol generation device 1 (see FIG. 1) in the present embodiment are the same as those in Embodiment 1. That is, the aerosol generation device 1 has the same external configuration and internal configuration as those in Embodiment 1.

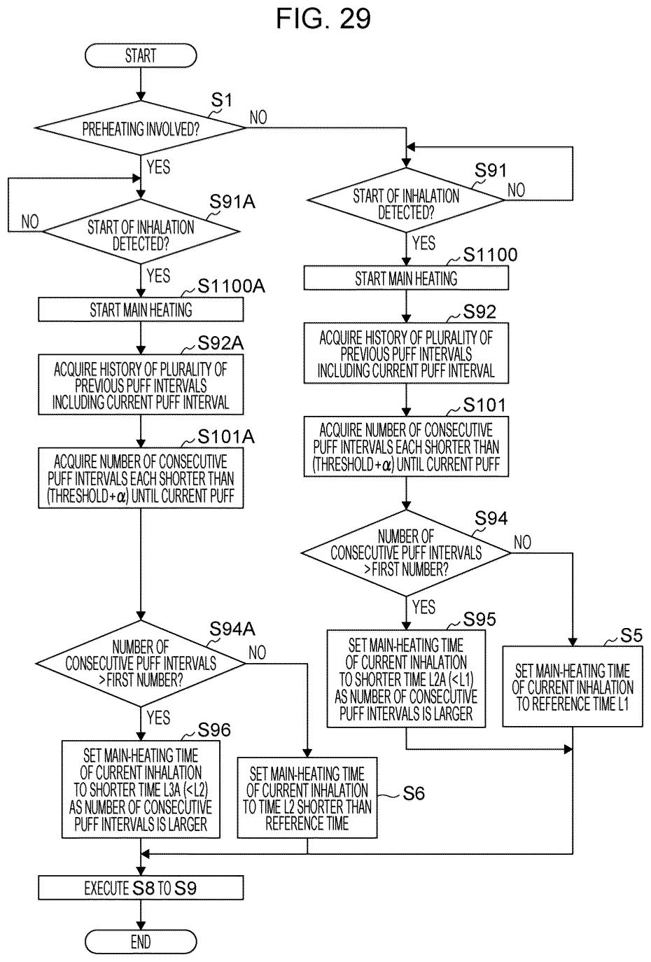

FIG. 29 is a flowchart illustrating an example of control of the main-heating time by the controller 117 (see FIG. 2) used in Embodiment 11. In FIG. 29, parts corresponding to those in FIG. 27 are denoted by corresponding reference numerals. The control by the controller 117 is implemented through execution of a program.

In the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 91). The determination of step 91 is repeated while a negative result is obtained in step 91.

If a positive result is obtained in step 91, the controller 117 starts the main heating (step 1100), and then acquires a history of a plurality of previous puff intervals including the current puff interval (step 92). In the present embodiment, since an actual measurement value is used instead of a predicted value, the current puff interval is also measured.

When the history of a plurality of previous puff intervals is acquired, the controller 117 acquires the number of consecutive puff intervals each shorter than a value obtained by adding a margin α to the first number for short puff determination (represented as “threshold+α” in FIG. 29) until the current puff (step 101).

The value obtained by adding the value of the margin α to the first number for short puff determination is a threshold for determination of a pseudo short puff. The value of the margin α is given in advance through an empirical rule or the like. The value of the margin α is an example of a third period.

The number acquired in step 101 is likely to be larger than the number acquired in step 93 (see FIG. 27).

Then, the controller 117 determines whether the number of consecutive puff intervals is larger than the first number (step 94).

If the number of consecutive puff intervals is equal to or less than the first number, the controller 117 obtains a negative result in step 94. In this case, the controller 117 sets the main-heating time of the current inhalation to the reference time L1 (step 5).

On the other hand, if the number of consecutive puff intervals is larger than the first number, the controller 117 obtains a positive result in step 94. In this case, the controller 117 sets the main-heating time of the current inhalation to the shorter time L2A (<L1) as the number of consecutive puff intervals is larger (step 95).

After the main-heating time is set in step 5 or step 95, the controller 117 sequentially executes step 8 and step 9, and completes one cycle of inhalation.

On the other hand, if a positive result is obtained in step 1 (i.e., if the preheating mode is on), the controller 117 determines whether the puff sensor 112 has detected the start of inhalation (step 91A). The determination of step 91A is repeated while a negative result is obtained in step 91A.

If a positive result is obtained in step 91A, the controller 117 starts the main heating (step 1100A) after the end of the preheating. Subsequently, the controller 117 acquires a history of a plurality of previous puff intervals including the current puff interval (step 92A). In the present embodiment, since an actual measurement value is used instead of a predicted value, the current puff interval is also measured.

When the history of a plurality of previous puff intervals is acquired, the controller 117 acquires the number of consecutive puff intervals each shorter than a value obtained by adding the margin to the threshold for short puff determination (i.e., the first number+α) until the current puff (step 101A).

The number acquired in step 101A is likely to be larger than the number acquired in step 93A (see FIG. 27).

Then, the controller 117 determines whether the number of consecutive puff intervals is larger than the first number (step 94A). The threshold used for the determination of step 94A may be different from that for step 94. For example, the threshold used for the determination of step 94A may be smaller than the threshold used for the determination of step 94.

If the number of consecutive puff intervals is equal to or less than the first number, the controller 117 obtains a negative result in step 94A. In this case, the controller 117 sets the main-heating time of the current inhalation to the time L2 shorter than the reference time (step 6). The main-heating time set when a negative result is obtained in step 94A is desirably shorter than the reference time L1, and need not be L2.

On the other hand, if the number of consecutive puff intervals is larger than the first number, the controller 117 obtains a positive result in step 94A. In this case, the controller 117 sets the main-heating time of the current inhalation to the shorter time L3A (<L2) as the number of consecutive puff intervals is larger (step 96).

After the main-heating time is set in step 6 or step 96, the controller 117 sequentially executes step 8 and step 9, and completes one cycle of inhalation.

In the present embodiment, the controller 117 counts the number of consecutive short puffs including a pseudo short puff. Thus, even if a pseudo short puff occurs consecutively, drying up is effectively prevented or reduced.

### Embodiment 12

The present embodiment describes a modification of Embodiments 1 to 7. In Embodiment 1, the main-heating times LT1 and LT11 for a puff determined to be a short puff are fixed values. That is, the time L2 is used without the preheating, and the time L3 is used with the preheating. In other words, the amount of electric power to be supplied to the heater 211 (see FIG. 2) during a short puff is always constant.

In the present embodiment, the amount of electric power to be supplied to the heater 211 during a short puff is decreased as the immediately preceding puff interval decreases.

The other configurations of the aerosol generation device 1 (see FIG. 1) in the present embodiment are the same as those in Embodiment 1. That is, the aerosol generation device 1 has the same external configuration and internal configuration as those in Embodiment 1.

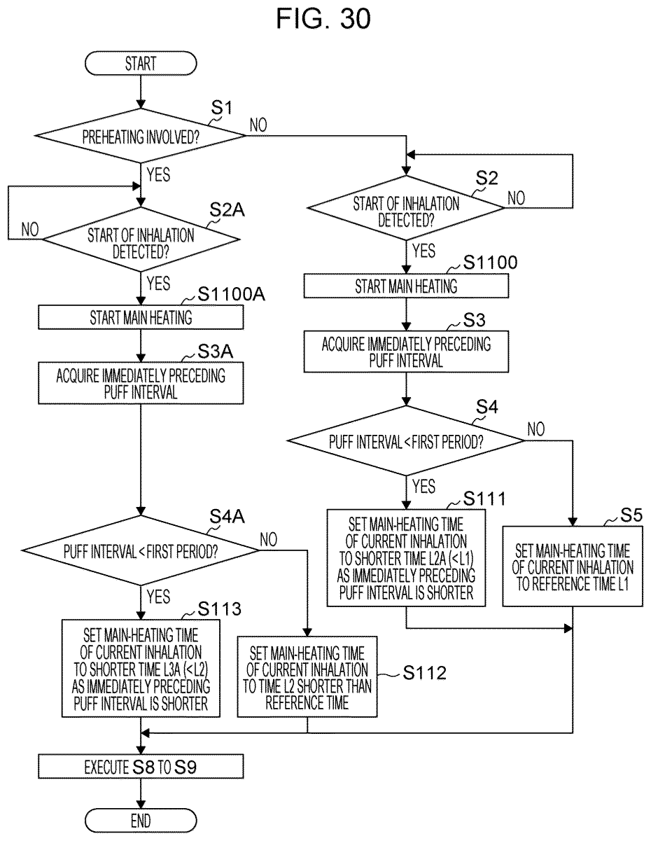

FIG. 30 is a flowchart illustrating an example of control of the main-heating time by the controller 117 (see FIG. 2) used in Embodiment 12. In FIG. 30, parts corresponding to those in FIG. 4 are denoted by corresponding reference numerals. The control by the controller 117 is implemented through execution of a program. That is, FIG. 30 illustrates a modification of Embodiment 1.

Also in the present embodiment, first, the controller 117 determines whether the preheating is involved (step 1).

If a negative result is obtained in step 1 (i.e., if the preheating mode is off), the controller 117 determines whether the puff sensor 112 has detected the start of inhalation (step 2).

If the start of inhalation of the aerosol by the user is not detected, the controller 117 obtains a negative result in step 2. The controller 117 repeats the determination of step 2 while a negative result is obtained in step 2.

On the other hand, if the start of inhalation of the aerosol by the user is detected, the controller 117 obtains a positive result in step 2. If a positive result is obtained in step 2, the controller 117 starts the main heating (step 1100), and then acquires the immediately preceding puff interval (step 3).

When the puff interval is acquired, the controller 117 determines whether the puff interval is shorter than the first period (step 4).

If the puff interval is equal to or longer than the first period, the controller 117 obtains a negative result in step 4. In this case, the controller 117 sets the main-heating time of the current inhalation to the reference time L1 (step 5).

On the other hand, if the puff interval is shorter than the first period, the controller 117 obtains a positive result in step 4. In this case, the controller 117 sets the main-heating time of the current inhalation to the shorter time L2A (<L1) as the immediately preceding puff interval is shorter (step 111). The time L2A may be linearly shortened in accordance with the number of consecutive puff intervals, or may be shortened in a nonlinear manner such as a quadratic curve.

After the main-heating time is set in step 5 or step 111, the controller 117 sequentially executes step 8 and step 9, and completes one cycle of inhalation.

On the other hand, if a positive result is obtained in step 1 (i.e., if the preheating mode is on), the controller 117 determines whether the puff sensor 112 has detected the start of inhalation (step 2A).

If the start of inhalation of the aerosol by the user is not detected, the controller 117 obtains a negative result in step 2A. The controller 117 repeats the determination of step 2A while a negative result is obtained in step 2A.

On the other hand, if the start of inhalation of the aerosol by the user is detected, the controller 117 obtains a positive result in step 2A. If a positive result is obtained in step 2A, the controller 117 starts the main heating (step 1100A) after the end of the preheating. Subsequently, the controller 117 acquires the immediately preceding puff interval (step 3A).

When the puff interval is acquired, the controller 117 determines whether the puff interval is shorter than the first period (step 4A). The threshold used for the determination of step 4A may be different from that for step 4. For example, the threshold used for the determination of step 4A may be smaller than the threshold used for the determination of step 4.

If the puff interval is equal to or longer than the first period, the controller 117 obtains a negative result in step 4A. In this case, the controller 117 sets the main-heating time of the current inhalation to L2 shorter than the reference time (step 112).

On the other hand, if the puff interval is shorter than the first period, the controller 117 obtains a positive result in step 4A. In this case, the controller 117 sets the main-heating time of the current inhalation to the shorter time L3A as the immediately preceding puff interval is shorter (step 113).

After the main-heating time is set in step 112 or step 113, the controller 117 sequentially executes step 8 and step 9, and completes one cycle of inhalation.

In the present embodiment, the amount of electric power to be supplied to the heater 211 during the main-heating time is decreased as the immediately preceding puff interval decreases. Thus, drying up is less likely to occur.

When the method according to the present embodiment is applied to the method according to Embodiment 2, the length of the main-heating time is reduced as the time from the end of the immediately preceding heating to the start of the current heating decreases.

When the method according to the present embodiment is applied to the method according to Embodiment 3, the length of the main-heating time is reduced as the time from the end of the immediately preceding heating to the start of the current inhalation decreases.

When the method according to the present embodiment is applied to the method according to Embodiment 4, the length of the main-heating time is reduced as the time from the immediately preceding turn-off operation of the power button 11 to the current turn-on operation of the power button 11 decreases.

When the method according to the present embodiment is applied to the method according to Embodiment 5, the length of the main-heating time is reduced as the temperature of the heater 211 at the start of inhalation increases.

When the method according to the present embodiment is applied to the method according to Embodiment 6, the length of the main-heating time is reduced as the resistance value of the heater 211 at the start of inhalation decreases.

When the method according to the present embodiment is applied to the method according to Embodiment 7, the length of the main-heating time is reduced as the temperature of the liquid guide 212 at the start of inhalation increases.

### Embodiment 13

The present embodiment describes a control method that focuses on the amount of residual liquid in the aerosol source at the start of the main heating.

As described above, the aerosol source is supplied to the liquid guide 212 by capillary action. The present embodiment describes a control method in a case where the rate of liquid feeding by capillary action depends on the amount of residual liquid. For example, example control will be described in which, in a situation where the rate of liquid supply is decreased due to a decrease in the amount of residual liquid, the amount of liquid in the aerosol source that can be supplied during one inhalation is smaller than that when the amount of residual liquid is large. In this case, sufficient aerosol is not generated during one inhalation.

For this reason, if the main-heating time is the same regardless of the amount of residual liquid, the supply of the aerosol source is not in time, and a phenomenon similar to drying up may occur.

In the present embodiment, accordingly, the length of the main-heating time is controlled also in consideration of the amount of residual liquid.

An aerosol generation device 1 according to the present embodiment also has the same external configuration as that in Embodiment 1. However, the aerosol generation device 1 provided in the present embodiment has an internal configuration that is partially different from that in Embodiment 1.

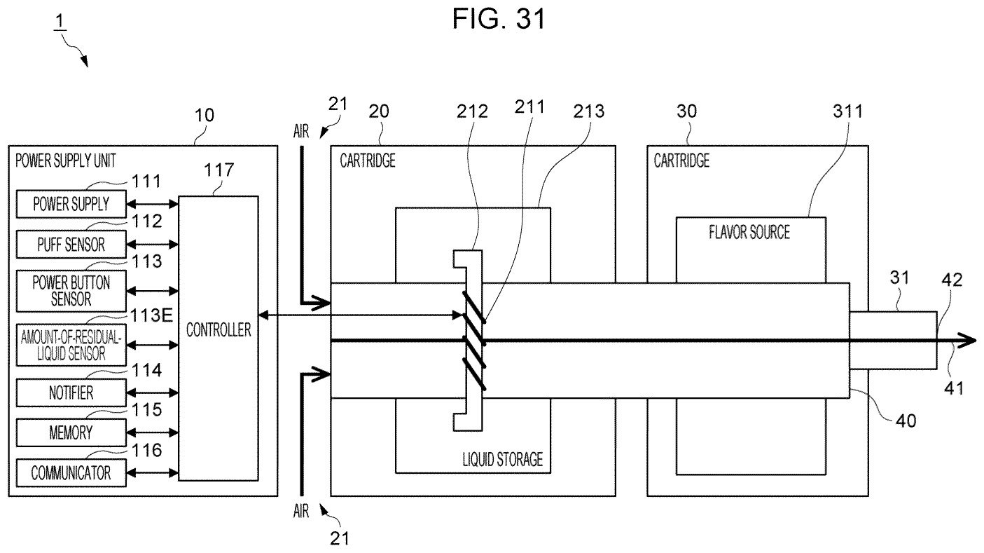

FIG. 31 is a diagram schematically illustrating an internal configuration of the aerosol generation device 1 provided in Embodiment 13. In FIG. 31, parts corresponding to those in FIG. 2 are denoted by corresponding reference numerals.

Unlike the aerosol generation device 1 illustrated in FIG. 2, the aerosol generation device 1 illustrated in FIG. 31 is provided with an amount-of-residual-liquid sensor 113E.

For example, a level switch, a level meter, an electrostatic capacitance sensor, or a sensor for measuring the distance to the liquid surface is used as the amount-of-residual-liquid sensor 113E. The distance to the liquid surface can be measured by, for example, the time taken until an ultrasonic wave, an electromagnetic wave, or a laser beam is reflected by the liquid surface and returns.

The amount of residual liquid to be finally used is corrected by the controller 117 using information on the posture of the aerosol generation device 1. For example, an output signal of a gyro sensor is used as the information on the posture.

In the present embodiment, the amount-of-residual-liquid sensor 113E is used. Alternatively, the amount of residual liquid may be determined by calculation. For example, the amount of liquid consumed for each inhalation can be calculated as a function of the amount of electric power to be supplied to the heater 211, and thus, the integrated value thereof is subtracted from the initial value to calculate the amount of residual liquid at each point in time.

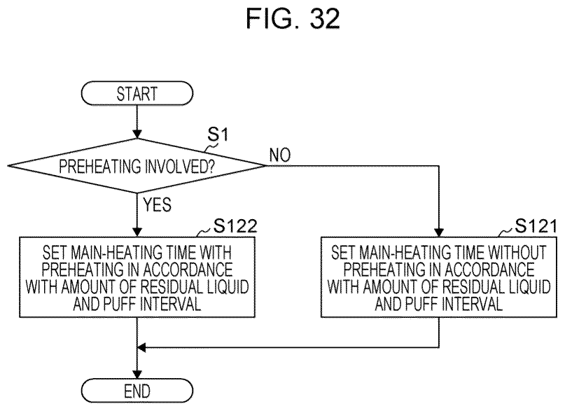

FIG. 32 is a flowchart illustrating an example of control of the main-heating time by the controller 117 (see FIG. 2) used in Embodiment 13. In FIG. 32, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 sets the main-heating time without the preheating in accordance with the amount of residual liquid and the puff interval (step 121).

On the other hand, if a positive result is obtained in step 1 (i.e., if the preheating mode is on), the controller 117 sets the main-heating time with the preheating in accordance with the amount of residual liquid and the puff interval (step 122).

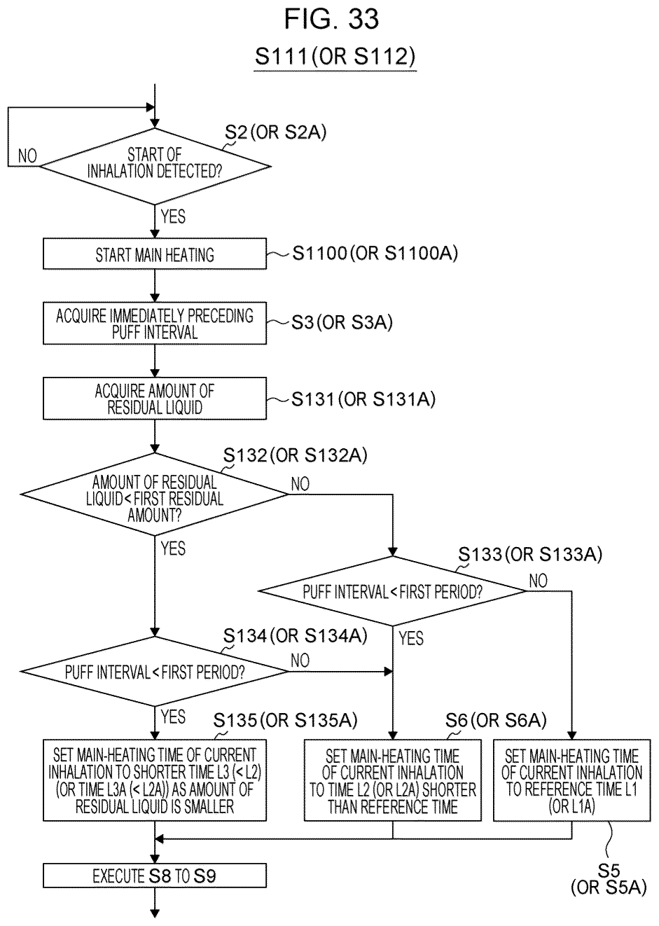

FIG. 33 is a flowchart illustrating an example process for setting the main-heating time without the preheating and an example process for setting the main-heating time with the preheating. In FIG. 33, parts corresponding to those in FIG. 4 are denoted by corresponding reference numerals. In FIG. 33, reference numerals without parentheses indicate the example process for setting the main-heating time without the preheating, and reference numerals in parentheses indicate the example process for setting the main-heating time with the preheating.

First, an example process for setting the main-heating time LT1 without the preheating will be described.

The controller 117 determines whether the puff sensor 112 (see FIG. 2) has detected the start of inhalation (step 2).

If the start of inhalation of the aerosol by the user is not detected, the controller 117 obtains a negative result in step 2. The controller 117 repeats the determination of step 2 while a negative result is obtained in step 2.

On the other hand, if the start of inhalation of the aerosol by the user is detected, the controller 117 obtains a positive result in step 2. If a positive result is obtained in step 2, the controller 117 starts the main heating (step 1100), and then acquires the immediately preceding puff interval (step 3). Subsequently, the controller 117 acquires the amount of residual liquid (step 131).

When the amount of residual liquid is acquired, the controller 117 determines whether the amount of residual liquid is smaller than a first residual amount (step 132). The first residual amount is determined by, for example, the relationship between the rate of liquid feeding according to the amount of residual liquid and the amount of liquid required when the main-heating time is the reference time L1.

If the amount of residual liquid is equal to or greater than the first residual amount, the controller 117 obtains a negative result in step 132. In this case, the controller 117 determines whether the puff interval is shorter than the first period (step 133).

If the puff interval is equal to or longer than the first period, the controller 117 obtains a negative result in step 133. If a negative result is obtained in step 133, the controller 117 sets the main-heating time LT1 of the current inhalation to the reference time L1 (step 5).

On the other hand, if the puff interval is shorter than the first period, the controller 117 obtains a positive result in step 133. In this case, the controller 117 sets the main-heating time of the current inhalation to the time L2 shorter than the reference time (step 6).

If a positive result is obtained in step 132, the controller 117 determines whether the puff interval is shorter than the first period (step 134). The threshold used for the determination of step 134 may be different from that for step 133. For example, the threshold used for the determination of step 134 may be smaller than the threshold used for the determination of step 133.

If the puff interval is equal to or longer than the first period, the controller 117 obtains a negative result in step 134. If a negative result is obtained in step 134, the controller 117 sets the main-heating time of the current inhalation to the time L2 shorter than the reference time (step 6). The main-heating time set when a negative result is obtained in step 134 is desirably shorter than the reference time L1, and need not be L2.

On the other hand, if the puff interval is shorter than the first period, the controller 117 obtains a positive result in step 134. In this case, the controller 117 sets the main-heating time of the current inhalation to the shorter time L3 (<L2) as the amount of residual liquid is smaller (step 135). Also in this case, the main-heating time is shortened stepwise, for example. However, the main-heating time may be nonlinearly shortened in accordance with a quadratic curve or the like.

After the main-heating time LT1 is set in step 5, step 6, or step 135, the controller 117 sequentially executes step 8 and step 9, and completes one cycle of inhalation.

The foregoing is an example of setting of the main-heating time without the preheating.

Then, an example process for setting the main-heating time LT11 with the preheating will be described. The controller 117 determines whether the puff sensor 112 (see FIG. 2) has detected the start of inhalation (step 2A).

If the start of inhalation of the aerosol by the user is not detected, the controller 117 obtains a negative result in step 2A. The controller 117 repeats the determination of step 2A while a negative result is obtained in step 2A.

On the other hand, if the start of inhalation of the aerosol by the user is detected, the controller 117 obtains a positive result in step 2A. If a positive result is obtained in step 2A, the controller 117 starts the main heating (step 1100A) after the end of the preheating. Subsequently, the controller 117 acquires the immediately preceding puff interval (step 3A), and then acquires the amount of residual liquid (step 131A).

When the amount of residual liquid is acquired, the controller 117 determines whether the amount of residual liquid is smaller than the first residual amount (step 132A).

If the amount of residual liquid is equal to or greater than the first residual amount, the controller 117 obtains a negative result in step 132A. In this case, the controller 117 determines whether the puff interval is shorter than the first period (step 133A).

If the puff interval is equal to or longer than the first period, the controller 117 obtains a negative result in step 133A. If a negative result is obtained in step 133A, the controller 117 sets the main-heating time of the current inhalation to a reference time LIA (step 5A).

On the other hand, if the puff interval is shorter than the first period, the controller 117 obtains a positive result in step 133A. In this case, the controller 117 sets the main-heating time of the current inhalation to the time L2A shorter than the reference time (step 6A).

If a positive result is obtained in step 132A, the controller 117 determines whether the puff interval is shorter than the first period (step 134A). The threshold used for the determination of step 134A may be different from that for step 133A. For example, the threshold used for the determination of step 134A may be smaller than the threshold used for the determination of step 133A.

If the puff interval is equal to or longer than the first period, the controller 117 obtains a negative result in step 134A. If a negative result is obtained in step 134A, the controller 117 sets the main-heating time of the current inhalation to the time L2A shorter than the reference time (step 6A). The main-heating time set when a negative result is obtained in step 134A is desirably shorter than the reference time L1, and need not be L2.

On the other hand, if the puff interval is shorter than the first period, the controller 117 obtains a positive result in step 134A. In this case, the controller 117 sets the main-heating time of the current inhalation to the shorter time L3A (<L2A) as the amount of residual liquid is smaller (step 135A).

After the main-heating time LT11 is set in step 5A, step 6A, or step 135A, the controller 117 sequentially executes step 8 and step 9, and completes one cycle of inhalation.

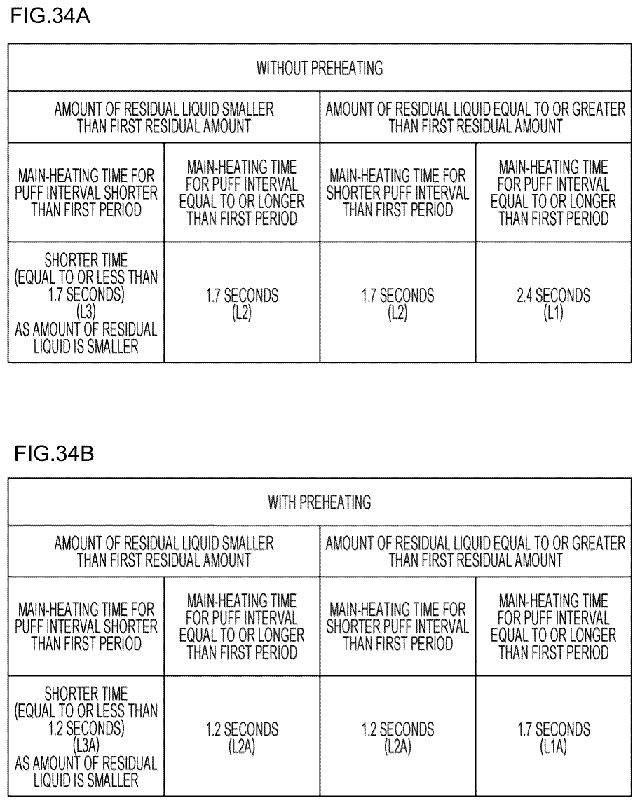

FIGS. 34A and 34B are diagrams illustrating an example of setting of the main-heating time according to the amounts of residual liquid in the absence of preheating and in the presence of preheating. FIG. 34A illustrates an example of setting of the main-heating time LT1 without the preheating, and FIG. 34B illustrates an example of setting of the main-heating time LT11 with the preheating.

First, the main-heating time LT1 without the use of the preheating is set to 2.4 seconds (i.e., L1) when the amount of residual liquid is equal to or greater than the first residual amount and the puff interval is long. On the other hand, when the amount of residual liquid is smaller than the first residual amount and a short puff occurs, the main-heating time LT1 is set to 1.7 seconds (i.e., L2).

Likewise, the main-heating time LT1 without the use of the preheating is set to 1.7 seconds (i.e., L2) when the amount of residual liquid is smaller than the first residual amount and the puff interval is long. This is because even when the amount of residual liquid is small, the risk of drying up is low if the puff interval is long. On the other hand, when the amount of residual liquid is smaller than the first residual amount and a short puff occurs, the main-heating time LT1 is set to a variable value equal to or less than 1.7 seconds (i.e., L3).

By contrast, the main-heating time LT11 with the use of the preheating is set to 1.7 seconds (i.e., LIA) when the amount of residual liquid is equal to or greater than the first residual amount and the puff interval is long. On the other hand, when the amount of residual liquid is equal to or greater than the first residual amount, but a short puff occurs, the main-heating time LT11 is set to 1.2 seconds (i.e., L2A).

Likewise, the main-heating time LT11 with the use of the preheating is set to 1.2 seconds (i.e., L2A) when the amount of residual liquid is smaller than the first residual amount and the puff interval is long. This is because even when the amount of residual liquid is small, the risk of drying up is low if the puff interval is long. On the other hand, when the amount of residual liquid is smaller than the first residual amount and a short puff occurs, the main-heating time LT11 is set to a variable value equal to or less than 1.2 seconds (i.e., L3A).

When the method according to the present embodiment is applied to the method according to Embodiment 2, the time from the end of the immediately preceding heating to the start of the current heating is desirably used as the puff interval.

When the method according to the present embodiment is applied to the method according to Embodiment 3, the time from the end of the immediately preceding heating to the start of the current inhalation is desirably used as the puff interval.

When the method according to the present embodiment is applied to the method according to Embodiment 4, the time from the immediately preceding turn-off operation of the power button 11 to the current turn-on operation of the power button 11 is desirably used as the puff interval.

When the method according to the present embodiment is applied to the method according to Embodiment 5, the temperature of the heater 211 at the start of inhalation and the determination step thereof are desirably used for the puff interval and the determination step thereof.

When the method according to the present embodiment is applied to the method according to Embodiment 6, the resistance value of the heater 211 at the start of inhalation and the determination step thereof are desirably used for the puff interval and the determination step thereof.

When the method according to the present embodiment is applied to the method according to Embodiment 7, the temperature of the liquid guide 212 at the start of inhalation and the determination step thereof are desirably used for the puff interval and the determination step thereof.

### Embodiment 14

The present embodiment describes a control operation performed when overheating is detected during the main-heating time. An aerosol generation device 1 according to the present embodiment also has the same external configuration as that in Embodiment 1. The present embodiment can be combined with any of Embodiments 1 to 7, except that the coil temperature sensor 113A (see FIG. 13) is provided.

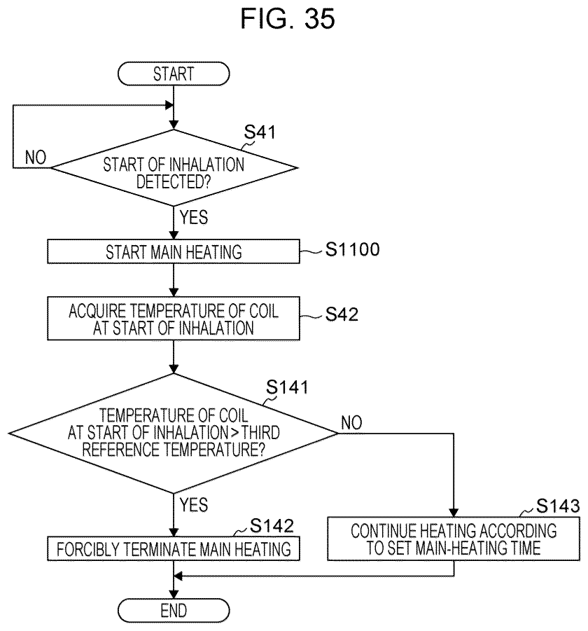

FIG. 35 is a flowchart illustrating example control of the main-heating time by the controller 117 (see FIG. 2) used in Embodiment 14. In FIG. 35, parts corresponding to those in FIG. 14 are denoted by corresponding reference numerals. The control by the controller 117 is implemented through execution of a program.

The processing operation according to the present embodiment is executed regardless of the presence or absence of preheating.

First, the controller 117 determines whether the puff sensor 112 has detected the start of inhalation (step 41). The controller 117 repeats the determination of step 41 while a negative result is obtained in step 41.

On the other hand, if the start of inhalation of the aerosol by the user is detected, the controller 117 obtains a positive result in step 41. If a positive result is obtained in step 41, the controller 117 starts the main heating (step 1100), and then acquires the temperature of the coil at the start of inhalation (step 42).

When the temperature of the coil is acquired, the controller 117 determines whether the temperature of the coil at the start of inhalation is higher than a third reference temperature (step 141). The third reference temperature is a threshold for determination of overheating.

If the acquired temperature is higher than the third reference temperature, the controller 117 obtains a positive result in step 141. In this case, the controller 117 forcibly terminates the main heating (step 142). That is, even if the set main-heating time remains, the controller 117 ends the supply of electric power to the heater 211.

Even if the supply of electric power ends, the temperature of the heater 211 is kept high for a while. Thus, the generation of the aerosol continues for a while.

Since heating ends before the set main-heating time expires, the amount of time for cooling until the next inhalation can be extended as compared with a case where the heating is continued until the main-heating time expires. As a result, the liquid temperature of the aerosol source at the start of the next inhalation is likely to be lower than that in a case where the control according to the present embodiment is not used. In addition, the overheating is eliminated, thereby making it possible to continue the use of the aerosol generation device 1 within the design temperature.

On the other hand, if a negative result is obtained in step 141, the controller 117 continues the heating according to the set main-heating time (step 143).

### Embodiment 15

The present embodiment describes another control operation performed when overheating is detected during the main-heating time. An aerosol generation device 1 according to the present embodiment also has the same external configuration as that in Embodiment 1. The present embodiment can be combined with any of Embodiments 1 to 7, except that the liquid temperature sensor 113C (see FIG. 19) is provided.

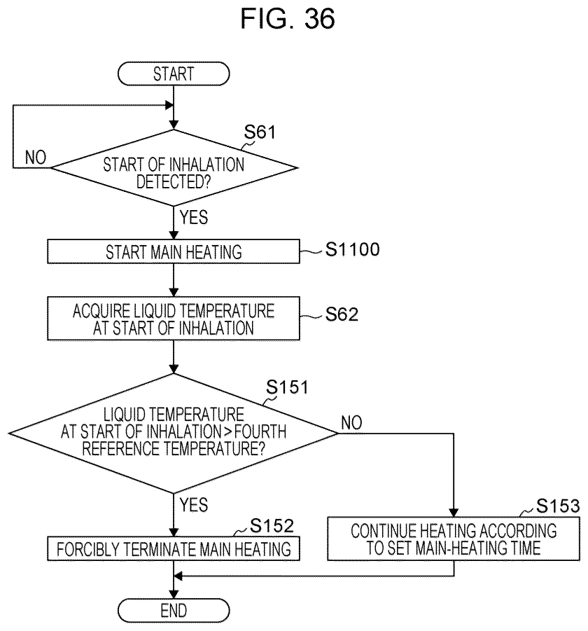

FIG. 36 is a flowchart illustrating example control of the main-heating time by the controller 117 (see FIG. 2) used in Embodiment 15. In FIG. 36, parts corresponding to those in FIG. 20 are denoted by corresponding reference numerals. The control by the controller 117 is implemented through execution of a program.

The controller 117 according to the present embodiment also determines whether the puff sensor 112 has detected the start of inhalation (step 61).

The controller 117 repeats the determination of step 61 while a negative result is obtained in step 61.

If a positive result is obtained in step 61, the controller 117 starts the main heating (step 1100), and then acquires the liquid temperature at the start of inhalation (step 62). The liquid temperature, as used here, is the temperature of the liquid guide 212.

When the liquid temperature is acquired, the controller 117 determines whether the liquid temperature at the start of inhalation is higher than a fourth reference temperature (step 151). The fourth reference temperature is a threshold for determination of overheating.

If the acquired liquid temperature is higher than the fourth reference temperature, the controller 117 obtains a positive result in step 151. In this case, the controller 117 forcibly terminates the main heating (step 152). That is, even if the set main-heating time remains, the controller 117 ends the supply of electric power to the heater 211.

Even if the supply of electric power ends, the temperature of the heater 211 is kept high for a while. Thus, the generation of the aerosol continues for a while.

Since heating ends before the set main-heating time expires, the amount of time for cooling until the next inhalation can be extended as compared with a case where the heating is continued until the main-heating time expires. As a result, the liquid temperature of the aerosol source at the start of the next inhalation is likely to be lower than that in a case where the control according to the present embodiment is not used. In addition, the overheating is eliminated, thereby making it possible to continue the use of the aerosol generation device 1 within the design temperature.

On the other hand, if a negative result is obtained in step 151, the controller 117 continues the heating according to the set main-heating time (step 153).

### Embodiment 16

In the present embodiment, at the time of detection of a short puff, the main-heating time is not shortened, but the voltage value or the current value to be applied to the heater 211 is set to a low value, thereby preventing or reducing the occurrence of drying up.

The other configurations of the aerosol generation device 1 (see FIG. 1) in the present embodiment are the same as those in Embodiment 1. That is, the aerosol generation device 1 has the same external configuration and internal configuration as those in Embodiment 1.

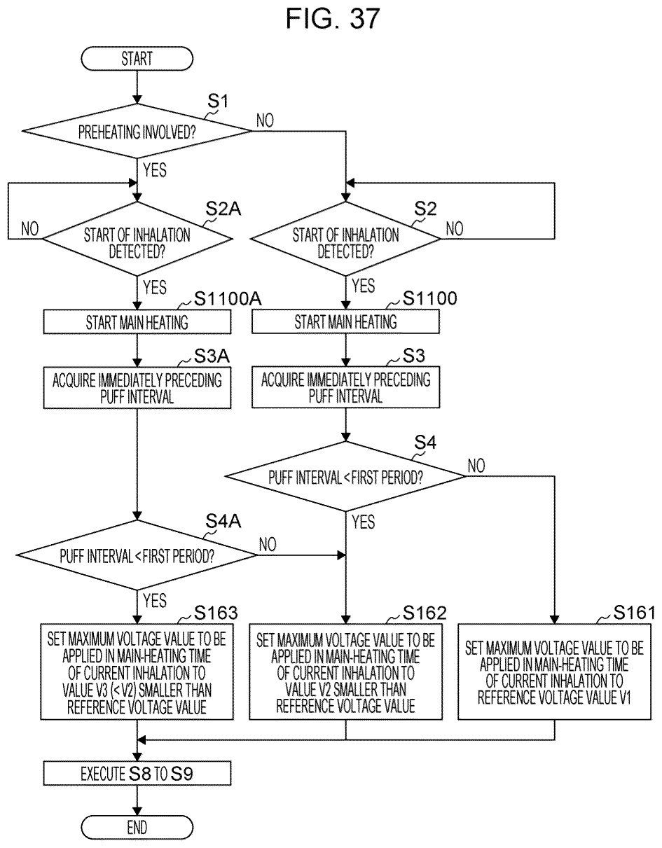

FIG. 37 is a flowchart illustrating an example of control of the main-heating time by the controller 117 (see FIG. 2) used in Embodiment 16. In FIG. 37, parts corresponding to those in FIG. 4 are denoted by corresponding reference numerals. The control by the controller 117 is implemented through execution of a program.

Also in the present embodiment, first, the controller 117 determines whether the preheating is involved (step 1).

If a negative result is obtained in step 1 (i.e., if the preheating mode is off), the controller 117 determines whether the puff sensor 112 (see FIG. 2) has detected the start of inhalation (step 2).

If the start of inhalation of the aerosol by the user is not detected, the controller 117 obtains a negative result in step 2. The controller 117 repeats the determination of step 2 while a negative result is obtained in step 2.

On the other hand, if the start of inhalation of the aerosol by the user is detected, the controller 117 obtains a positive result in step 2. If a positive result is obtained in step 2, the controller 117 starts the main heating (step 1100), and then acquires the immediately preceding puff interval (step 3).

When the puff interval is acquired, the controller 117 determines whether the puff interval is shorter than the first period (step 4).

If the puff interval is equal to or longer than the first period, the controller 117 obtains a negative result in step 4. In this case, the controller 117 sets the maximum voltage value to be applied in the main-heating time of the current inhalation to a reference voltage value V1 (step 161). The reference voltage value, as used here, is the same as the voltage value used in, for example, Embodiment 1. The reference voltage value V1, as used here, is an example of a second maximum voltage value. As described above, it is also possible to specify a current value.

If a positive result is obtained in step 4, the controller 117 sets the maximum voltage value to be applied in the main-heating time of the current inhalation to a value V2 smaller than the reference voltage value (step 162).

After the main-heating time LT1 is set in step 161 or step 162, the controller 117 sequentially executes step 8 and step 9.

On the other hand, if a positive result is obtained in step 1 (i.e., if the preheating mode is on), the controller 117 determines whether the puff sensor 112 (see FIG. 2) has detected the start of inhalation (step 2A).

If the start of inhalation of the aerosol by the user is not detected, the controller 117 obtains a negative result in step 2A. The controller 117 repeats the determination of step 2A while a negative result is obtained in step 2A.

On the other hand, if the start of inhalation of the aerosol by the user is detected, the controller 117 obtains a positive result in step 2A. If a positive result is obtained in step 2A, the controller 117 starts the main heating (step 1100A) after the end of the preheating. Subsequently, the controller 117 acquires the immediately preceding puff interval (step 3A).

When the puff interval is acquired, the controller 117 determines whether the puff interval is shorter than the first period (step 4A). The threshold used for the determination of step 4A may be different from that for step 4. For example, the threshold used for the determination of step 4A may be smaller than the threshold used for the determination of step 4.

If the puff interval is equal to or longer than the first period, the controller 117 obtains a negative result in step 4A. In this case, the controller 117 sets the maximum voltage value to be applied in the main-heating time of the current inhalation to the value V2 smaller than the reference voltage value (step 162). The main-heating time set when a negative result is obtained in step 4A is desirably shorter than the reference voltage value V1, and need not be V2.

If a positive result is obtained in step 4A, the controller 117 sets the maximum voltage value to be applied in the main-heating time of the current inhalation to a value V3 (<V2) smaller than the reference voltage value (step 163).

After the main-heating time LT11 is set in step 162 or step 163, the controller 117 sequentially executes step 8 and step 9.

As described above, in the present embodiment, in the case of a short puff, the main-heating time is not shortened, but the maximum voltage value is set to a low value. The maximum voltage value set in step 163 is an example of a first maximum voltage value. As a result, the electric power to be supplied to the heater 211 within the main-heating time is smaller than that in a case where the puff interval is not short. That is, the electric power is smaller than the reference value. As the maximum voltage value is set to be lower than the reference voltage value, the electric power to be supplied to the heater 211 within the main-heating time decreases. It should be noted that a current value, instead of a voltage value, can be specified.

### Embodiment 17

In the embodiments described above, the aerosol generation device 1 having the power button 11 (see FIG. 1) has been described. However, the present disclosure is also applicable to an aerosol generation device 1 that does not have the power button 11.

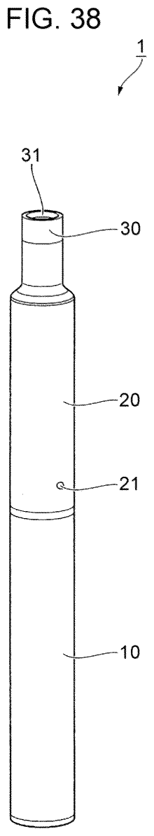

FIG. 38 is a diagram illustrating an example external configuration of an aerosol generation device 1 provided in Embodiment 17. In FIG. 38, parts corresponding to those in FIG. 1 are denoted by corresponding reference numerals.

In the present embodiment, in response to detection of the start of inhalation by the user, the supply of electric power to the heater 211 (see FIG. 2) is started.

### Embodiment 18

The present embodiment describes an aerosol generation device 1 having a mechanism for heating a substrate containing an aerosol, in addition to a mechanism for heating an aerosol source as a liquid.

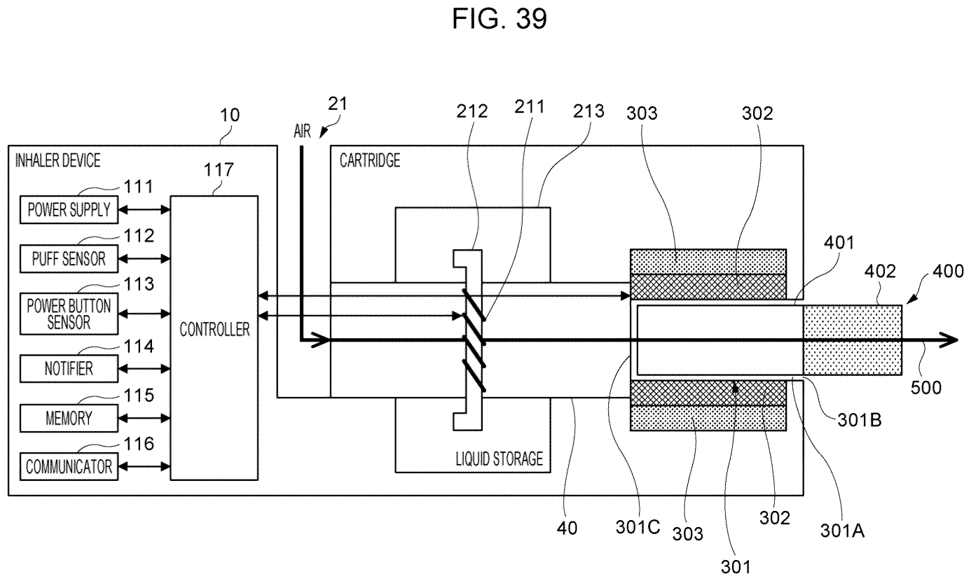

FIG. 39 is a diagram schematically illustrating an example internal configuration of the aerosol generation device 1 provided in Embodiment 18. In FIG. 39, parts corresponding to those in FIG. 2 are denoted by corresponding reference numerals.

The aerosol generation device 1 illustrated in FIG. 39 is provided with the power supply 111, the puff sensor 112, the power button sensor 113, the notifier 114, the memory 115, the communicator 116, the controller 117, the heater 211, the liquid guide 212, and the liquid storage 213. The aerosol generation device 1 illustrated in FIG. 39 is further provided with a holder 301 used to hold a stick substrate 400, a heater 302 disposed on the outer circumference of the holder 301, and a heat insulator 303 disposed on the outer circumference of the heater 302.

In FIG. 39, the holder 301 is loaded with the stick substrate 400. The user performs an inhalation operation with the stick substrate 400 inserted in the holder 301.

In the aerosol generation device 1, the airflow path 40 is formed for conveying the air flowing in through the air inlet hole 21 to a bottom 301C of the holder 301 via the liquid guide 212. With this configuration, the air flowing in through the air inlet hole 21 in response to the inhalation action of the user flows through the inside of the airflow path 40 along an arrow 500. This flow of air is mixed with an aerosol generated by the heater 211 and an aerosol generated by the heater 302.

In the present embodiment, the controller 117 controls a heating operation of the heater 211 and also controls a heating operation of the heater 302. At this time, the controller 117 acquires information such as the temperature of the heater 302 by using a sensor (not illustrated).

The holder 301 has a substantially cylindrical shape. Thus, the inside of the holder 301 is hollow. The hollow is referred to as an internal space 301A. The internal space 301A has substantially the same diameter as the stick substrate 400 and accommodates the stick substrate 400 inserted through an opening 301B while being in contact with the leading end of the stick substrate 400. That is, the stick substrate 400 is held in the internal space 301A.

The holder 301 has the bottom 301C on a side thereof opposite to the side adjacent to the opening 301B. The bottom 301C is coupled to the airflow path 40.

The inside diameter of the holder 301 is smaller than the outside diameter of the stick substrate 400 in at least part of the tubular body in the height direction. With this configuration, the outer circumference surface of the stick substrate 400 inserted into the internal space 301A through the opening 301B is subjected to pressure by the inner wall of the holder 301. This pressure holds the stick substrate 400 in the holder 301.

The holder 301 also has a function of defining the flow path of air passing through the stick substrate 400. The bottom 301C, as used here, is an inlet hole through which air enters the holder 301, and the opening 301B is an outlet hole through which air leaves the holder 301.

The stick substrate 400 is a substantially cylindrical member. The stick substrate 400 provided in the present embodiment includes a substrate 401 and an inhalation port 402.

The substrate 401 accommodates an aerosol source. The aerosol source is a substance that is atomized when heated to generate an aerosol. Examples of the aerosol source accommodated in the substrate 401 include a substance derived from tobacco, such as a processed product obtained by forming shredded tobacco or a tobacco raw material into a granular shape, a sheet shape, or a powder shape. However, the aerosol source accommodated in the substrate 401 may include a substance not derived from tobacco, which is made from non-tobacco plants (such as mints and herbs, for example). For example, the aerosol source may include a flavor component such as menthol.

When the aerosol generation device 1 is a medical inhaler, the aerosol source of the stick substrate 400 may contain medicine to be inhaled by a patient. The aerosol source is not limited to a solid and may be, for example, a liquid such as polyhydric alcohol, for example, glycerine or propylene glycol, or water.

At least a portion of the substrate 401 is accommodated in the internal space 301A of the holder 301 with the stick substrate 400 remaining held in the holder 301.

The inhalation port 402 is a member to be held in the user's mouth during inhalation. At least a portion of the inhalation port 402 protrudes from the opening 301B with the stick substrate 400 remaining held in the holder 301.

When the user holds the inhalation port 402 protruding from the opening 301B in their mouth and inhales, as described above, air flows into the bottom 301C of the holder 301 through the air inlet hole 21. The air having flowed in passes through the internal space 301A of the holder 301 and the substrate 401 and reaches the inside of the user's mouth. The gas passing through the internal space 301A of the holder 301 and the substrate 401 is mixed with an aerosol generated from the substrate 401.

The heater 302 heats the aerosol source contained in the substrate 401 to atomize the aerosol source and generate an aerosol. The heater 302 is made of any material such as metal or polyimide. For example, the heater 302 is formed in a film shape and is disposed so as to cover the outer circumference of the holder 301.

When the heater 302 produces heat, the aerosol source contained in the stick substrate 400 is heated from the outer circumference of the stick substrate 400 and atomized to generate an aerosol.

The heater 302 produces heat when supplied with electric power from the power supply 111. For example, when a predetermined user input is detected by a sensor or the like (not illustrated), supply of electric power to the heater 302 is started, and an aerosol is generated.

When the temperature of the stick substrate 400 reaches a predetermined temperature as a result of heating by the heater 302, the generation of aerosol is started, allowing the user to inhale the aerosol.

Thereafter, when a predetermined user input is detected by the sensor or the like (not illustrated), the supply of electric power to the heater 302 is stopped.

While the inhalation by the user is detected by the puff sensor 112, the supply of electric power to the heater 302 may be continued to keep generating an aerosol.

### Other Embodiments

While embodiments of the present disclosure have been described above, the technical scope of the present disclosure is not limited to the scope described in the embodiments described above. It is apparent from the description of the claims that various modifications or improvements made to the embodiments described above are also included in the technical scope of the present disclosure.

For example, the embodiments described above have described a case where the heating stop time is acquired after the start of the preheating (step 12A (see FIG. 7)). Alternatively, the heating stop time may be acquired before the start of the preheating.

For example, in the embodiments described above, the length of the main-heating time is controlled in accordance with the length of the heating stop time. Alternatively, the length of the preheating time may be controlled in accordance with the length of the heating stop time, or the lengths of both the main-heating time and the preheating time may be controlled. That is, in a case where preheating is performed before main heating, the amount of electric power to be supplied to the heater 211 during the preheating may be controlled to be smaller than the reference value. The control of the preheating time includes shortening the length of the preheating time with respect to a reference length and setting the preheating time to zero.

Alternatively, in a case where preheating is performed before main heating, the amount of electric power to be supplied to the heater 211 during the preheating and the main heating may be controlled to be smaller than the reference value. The method for reducing the amount of electric power may be similar to the method for controlling the amount of electric power to be supplied to the heater 211 during the main heating to be small.

### REFERENCE SIGNS LIST

1 aerosol generation device
10 power supply unit
11 power button
20, 30 cartridge
21 air inlet hole
40 airflow path
42 air outlet hole
112 puff sensor
113 power button sensor
113A coil temperature sensors
113B resistance value sensor
113C liquid temperature sensor
113D air temperature sensor
113E amount-of-residual-liquid sensor
117 controller
211, 302 heater
212 liquid guide
213 liquid storage

1. A circuit unit of an aerosol generation device, comprising:
a controller that controls supply of electric power to a load that heats an aerosol source, wherein
in a case where first control for heating the load to a first temperature at which an aerosol is generated is preceded by second control for heating the load to a second temperature lower than the first temperature, the controller performs control such that at least one of an amount of electric power to be supplied to the load in the first control and an amount of electric power to be supplied to the load in the second control is smaller than a reference value when an interval between inhalations of the aerosol is shorter than a first period.

2. The circuit unit of an aerosol generation device according to claim 1, further comprising:
a first sensor that detects inhalation of the aerosol by a user, wherein
the controller makes at least one of a time for supplying electric power to the load in the first control and a time for supplying electric power to the load in the second control shorter than a second period when a time from an end of an immediately preceding inhalation detected by the first sensor to a start of a current inhalation detected by the first sensor is shorter than the first period.

3. The circuit unit of an aerosol generation device according to claim 1, wherein
the controller makes at least one of a time for supplying electric power to the load in the first control and a time for supplying electric power to the load in the second control shorter than a second period when a time from an end of immediately preceding heating at which generation of the aerosol ends to a start of current heating is shorter than the first period.

4. The circuit unit of an aerosol generation device according to claim 1, further comprising:
a first sensor that detects inhalation of the aerosol by a user, wherein
the controller makes at least one of a time for supplying electric power to the load in the first control and a time for supplying electric power to the load in the second control shorter than a second period when a time from an end of immediately preceding heating at which generation of the aerosol from the aerosol source ends to a start of a current inhalation detected by the first sensor is shorter than the first period.

5. The circuit unit of an aerosol generation device according to claim 1, comprising:
an operation unit that receives a user operation related to supply and stop of supply of electric power to the load, wherein
the controller makes at least one of a time for supplying electric power to the load in the first control and a time for supplying electric power to the load in the second control shorter than a second period when a time from an immediately preceding stop of supply of electric power in response to a user operation on the operation unit to a current start of supply of electric power is shorter than the first period.

6. The circuit unit of an aerosol generation device according to claim 1, further comprising:
a first sensor that detects inhalation of the aerosol by a user; and a second sensor that detects a temperature of the load, wherein
the controller makes at least one of a time for supplying electric power to the load in the first control and a time for supplying electric power to the load in the second control shorter than a second period when the temperature detected by the second sensor at a start of inhalation of the aerosol detected by the first sensor is higher than a first reference temperature.

7. The circuit unit of an aerosol generation device according to claim 1, further comprising:
a first sensor that detects inhalation of the aerosol by a user, wherein
the controller makes at least one of a time for supplying electric power to the load in the first control and a time for supplying electric power to the load in the second control shorter than a second period when a resistance value of the load at a start of inhalation of the aerosol detected by the first sensor is higher than a first resistance value.

8. The circuit unit of an aerosol generation device according to claim 1, further comprising:
a first sensor that detects inhalation of the aerosol by a user; and a third sensor that detects a temperature of the aerosol source, wherein
the controller makes at least one of a time for supplying electric power to the load in the first control and a time for supplying electric power to the load in the second control shorter than a second period when the temperature detected by the third sensor at a start of inhalation of the aerosol detected by the first sensor is higher than a second reference temperature.

9. The circuit unit of an aerosol generation device according to claim 1, wherein
the controller predicts a next interval from a tendency of a plurality of previous intervals between inhalations of the aerosol, and when the predicted interval is shorter than the first period, the controller sets at least one of a time for supply of electric power to the load in the first control and a time for supply of electric power to the load in the second control for a next inhalation to be shorter than a second period.

10. The circuit unit of an aerosol generation device according to claim 1, wherein
the controller acquires measurement values of a plurality of previous intervals between inhalations of the aerosol, and when the number of consecutive appearances of a measurement value shorter than the first period exceeds a first number, the controller performs control such that at least one of a time for supply of electric power to the load in the first control and a time for supply of electric power to the load in the second control for next and subsequent inhalations decreases stepwise to be shorter than the second period with an increase in the number of consecutive appearances of the measurement value.

11. The circuit unit of an aerosol generation device according to claim 10, wherein
when one of the measurement values is longer than the first period, in a case where an exceeding time thereof is less than a third period, the controller performs calculation by including a number of inhalation thereof into the number of consecutive appearances of the measurement value.

12. The circuit unit of an aerosol generation device according to claim 1, wherein
when the interval between inhalations of the aerosol is shorter than the first period, the controller performs control such that at least one of an amount of electric power to be supplied to the load in the first control and an amount of electric power to be supplied to the load in the second control decreases as the interval decreases.

13. The circuit unit of an aerosol generation device according to claim 1, wherein
when a residual amount of the aerosol source is smaller than a first residual amount, the controller performs control such that at least one of an amount of electric power to be supplied to the load in the first control and an amount of electric power to be supplied to the load in the second control decreases as the residual amount decreases.

14. The circuit unit of an aerosol generation device according to claim 1, further comprising:
a second sensor that detects a temperature of the load, wherein
the controller forcibly terminates heating of the load at a point in time when the temperature detected by the second sensor in a duration of the first control reaches a third reference temperature.

15. The circuit unit of an aerosol generation device according to claim 1, further comprising:
a third sensor that detects a temperature of the aerosol source, wherein
the controller forcibly terminates heating of the load at a point in time when the temperature detected by the third sensor in a duration of the first control reaches a fourth reference temperature.

16. The circuit unit of an aerosol generation device according to claim 1, wherein
when the interval between inhalations of the aerosol is shorter than the first period, the controller controls a first maximum voltage value to be supplied to the load to generate the aerosol, to a value smaller than a second maximum voltage value to be supplied to the load when the interval between inhalations of the aerosol is longer than the first period.

17. An aerosol generation device comprising:
a controller that controls supply of electric power to a load that heats an aerosol source, wherein
in a case where first control for heating the load to a first temperature at which an aerosol is generated is preceded by second control for heating the load to a second temperature lower than the first temperature, the controller performs control such that at least one of an amount of electric power to be supplied to the load in the first control and an amount of electric power to be supplied to the load in the second control is smaller than a reference value when an interval between inhalations of the aerosol is shorter than a first period.

18. A non-transitory computer readable medium storing a program for causing a computer that controls supply of electric power to a load that heats an aerosol source to implement:
a function of, in a case where first control for heating the load to a first temperature at which an aerosol is generated is preceded by second control for heating the load to a second temperature lower than the first temperature, performing control such that at least one of an amount of electric power to be supplied to the load in the first control and an amount of electric power to be supplied to the load in the second control is smaller than a reference value when an interval between inhalations of the aerosol is shorter than a first period.
